(19) United States
(12) Patent Application Publication
(10) Pub. No.: US 2026/0065939 A1
(43) Pub. Date: Mar. 5, 2026

(54) USING FUZZY MATCHING TO DETERMINE WHETHER SEGMENT(S) OF RESPONSIVE CONTENT, THAT IS GENERATED USING GENERATIVE MODEL(S), MATCH SEGMENT(S) OF ADDITIONAL DATA

(71) Applicant: GOOGLE LLC, Mountain View, CA (US)

(72) Inventors: Brian Carver, Emeryville, CA (US); Zhenkai Zhu, Fremont, CA (US); Amit Raul, San Jose, CA (US); Emma Rosgen, Mountain View, CA (US); Mahmoud Alnahlawi, Santa Cruz, CA (US); Steve Krawczyk, Campbell, CA (US); Ashley Lin, Piedmont, CA (US)

(21) Appl. No.: 19/242,357

(22) Filed: Jun. 18, 2025

Related U.S. Application Data
(60) Provisional application No. 63/688,669, filed on Aug. 29, 2024.

(51) Int. Cl. G11B 27/031; G06F 40/166

(52) U.S. Cl. CPC G11B 27/031; G06F 40/166

(57) ABSTRACT

Some implementations described herein relate to determining whether to modify segment(s) of responsive content, that is generated using a generative model (GM), based on a corresponding edit distance between the segment(s) of the responsive content and segment(s) of additional data. Processor(s) of a system can: receive user input associated with a client device, generate the responsive content using the GM and based on processing the user input, and determine whether to modify the segment(s) of the responsive content using the corresponding edit distance (e.g., fuzzy matching). Subsequent modification and/or processing of the responsive content can be dynamically adapted based on whether there is a match and, if there is a match, based on source(s) associated with the additional data that match. Further, the processor(s) can cause the responsive content, or modified responsive content, to be rendered at the client device.

### BACKGROUND

Various generative models (GMs) have been proposed that can be used to process image content, video content, audio content, natural language (NL) content (e.g., typed content or spoken content), and/or other input(s), to generate responsive content that is responsive to these input(s). These GMs are typically trained on enormous amounts of diverse data including data from, but not limited to, webpages, images, videos, electronic books, software code, electronic news articles, and machine translation data. Recently, these GMs have also been trained or otherwise fine-tuned to process user provided content that is in addition to a user input or prompt (e.g., document(s) or the like) and/or to obtain other content as part of a retrieval augmented generation (RAG) process. Accordingly, in performing various tasks, these GMs not only leverage the underlying data on which they were trained, but also leverage other data, such as user provided documents, search result documents obtained as part of a RAG process, and so on, in generating the responsive content. However, many of these GMs are not designed to ground the responsive content in the underlying data on which they were trained and/or other data. Further, many of these GMs are not designed to attribute sources of segment(s) of the responsive content in the underlying data on which they were trained and/or other data.

For example, in instances where the segment(s) of the responsive content generated using a given GM match segment(s) of underlying data on which the given GM was trained, processor(s) of a system may cause the segment(s) of the responsive content to be truncated, omitted, modified, attributed, or re-generated. However, some of these instances may be limited to situations where the segment(s) of the responsive content are an exact one-to-one match of the segment(s) of underlying data on which the given GM was trained. As a result, some implementations may under-utilize the system and/or over-utilize the system. For instance, if the segment(s) of the responsive content are a minor variant (but an exact one-to-one match) to user provided content that was processed to generate the responsive content, then the system may then proceed with determining if the segment(s) of the responsive content match any of the segment(s) of underlying data on which the given GM was trained, even though this additional processing may not be required. As a result, computational and/or network resources are wasted, and latency is introduced in causing the responsive content to be rendered.

### SUMMARY

Some implementations described herein relate to determining whether to modify segment(s) of responsive content, that is generated using a generative model (GM), based on a corresponding edit distance between the segment(s) of the responsive content and segment(s) of additional data. Processor(s) of a system can: receive user input associated with a client device, generate the responsive content using the GM and based on processing the user input, and determine whether to modify the segment(s) of the responsive content using the corresponding edit distance (e.g., fuzzy matching). Subsequent modification and/or processing of the responsive content can be dynamically adapted based on whether there is a match and, if there is a match, based on source(s) associated with the additional data that match. Further, the processor(s) can cause the responsive content, or modified responsive content, to be rendered at the client device. The additional data can include, for example, user provided content (e.g., documents associated with the user), portion(s) of search result document(s) obtained in response to the user input (e.g., using a retrieval augmented generation (RAG) process), and/or a GM training dataset that was utilized to initially train the dataset. The responsive content, or a modified version thereof, can then be rendered at the client device of the user.

In some implementations, the processor(s) can normalize and segment the additional data while the responsive content is being generated. For example, the processor(s) can normalize and segment the user provided content (if any) while the responsive content is being generated. Further, processor(s) can normalize and segment the search result documents (if any) while the responsive content is being generated. In additional or alternative implementations, the processor(s) can normalize and segment the GM training dataset prior to the user input being received.

In normalizing and segmenting the additional data, the processor(s) can utilize normalization operations and segmentation operations. The normalization operations can include, for example, converting all capitalized alphanumeric characters into lowercase alphanumeric characters, convert all punctuation into single spaces, convert all white space into single space, convert all double space into single space, and/or other normalization operations. The segmentation operations can include, for example, identifying a given word boundary in the normalized additional data and a fixed number of alphanumeric characters or a fixed number of words starting at the word boundary. These segmentation operations can be repeated for each word boundary in the additional data to generate the normalized and segmented additional data.

Moreover, and subsequent to the responsive content being generated, the processor(s) can normalize and segment the responsive content (e.g., in the same or similar manner described above with respect to the additional data). By normalizing and segmenting the additional data and the responsive content, the processor(s) can compare respective segments of the responsive content to respective segments of the additional data to determine whether a corresponding segment of the responsive content matches a corresponding segment of the additional data and based on whether the corresponding edit distance between a given normalized responsive content segment and a given normalized additional data segment satisfies an edit distance threshold. Notably, the corresponding edit distance can be determined as a function of: (a) a corresponding quantity of alphanumeric characters in the given normalized responsive content segment that need to be inserted, deleted, and/or substituted to result in the given normalized additional data segment; and (b) a corresponding total quantity of alphanumeric characters in the given normalized additional data segment.

For instance, assume that the given normalized additional data segment is “organize the worlds information and make it universally accessible and useful”. Further assume that the given normalized responsive content segment is “organize the worlds information and make it universally accessible and useful”. In this instance, the corresponding total quantity of alphanumeric characters in the given normalized additional data segment is 80, but no alphanumeric characters in the given normalized responsive content segment that need to be inserted, deleted, and/or substituted to result in the given normalized additional data segment. Accordingly, the corresponding edit distance is 0.0 and the given normalized responsive content segment is an exact match to the given normalized additional data segment.

Also, for instance, again assume that the given normalized additional data segment is “organize the worlds information and make it universally accessible and useful”. However, assume that the given normalized responsive content segment is “organizing the worlds information and make it universally accessible and useful”. In this instance, the corresponding total quantity of alphanumeric characters in the given normalized additional data segment is still 80, but 3 alphanumeric characters in the given normalized responsive content segment that need to be inserted, deleted, and/or substituted to result in the given normalized additional data segment (e.g., the difference between “organize” and “organizing” for substituting “e” with “ing”). Accordingly, the corresponding edit distance is 0.0375 (e.g., the 3 alphanumeric characters in the given normalized responsive content segment that need to be substituted divided by the 80 total alphanumeric characters in the given normalized additional data segment).

Although the above example is described with respect to the given normalized additional data segment being 80 characters, it should be understood that is for the sake of example and is not meant to be limiting. For instance, assume that the given normalized additional data segment is “our mission statement is to organize the worlds information and make it universally accessible and useful this mission statement was adopted in 1998.” Again assume that the given normalized responsive content segment is “organizing the worlds information and make it universally accessible and useful”. In this instance, the corresponding edit distance is still 0.0375 like in the preceding instance (e.g., the 3 alphanumeric characters in the given normalized responsive content segment that need to be substituted divided by the 80 total alphanumeric characters in the given normalized additional data segment even though the given normalized additional data segment precedes this segment with “our mission statement is to” and follows this segment with “this mission statement was adopted in 1998”).

In various implementations, the processor(s) can prioritize certain types of additional data to determine whether a corresponding segment of the responsive content matches a corresponding segment of the additional data. For example, the processor(s) can initially compare respective segments of the responsive content to respective segments of any user provided content, then compare respective segments of the responsive content to respective segments of any search result documents, and then compare respective segments of the responsive content to respective segments of the GM training dataset. By prioritizing certain types of additional data in these and other manners, the processor(s) can balance utilization of computational resources.

For instance, if a corresponding segment of the responsive content matches a corresponding segment of user provided data, then there is no need to attribute or modify the corresponding segment of the responsive content. Put another way, since the user associated with the client device owns the user provided content, has control over the user provided content, and/or purports to own or otherwise control the user provided content, there is no need for the processor(s) to unnecessarily waste computational resources in attributing or otherwise modifying the responsive content, in further processing the corresponding segment of the responsive content, etc. As a result, these computational resources that would be unnecessarily wasted are conserved and latency in causing the responsive content to be rendered at the client device is reduced since the need for obviating further processing of the corresponding segment of the responsive content is eliminated.

However, if a corresponding segment of the responsive content does not match a corresponding segment of the user provided data, then the processor(s) can determine whether a corresponding segment of the responsive content matches a corresponding segment of any search result documents. Notably, a quantity of segments of the GM training dataset can be in the order of hundreds of billions or trillions of segments, which is orders of magnitude larger than a quantity of segments of the plurality of search result documents (or the corresponding portion(s) thereof). Accordingly, by determining whether a corresponding segment of the responsive content matches a corresponding segment of the plurality of search result documents (or the corresponding portion(s) thereof), a search space for the processor(s) to find a match is initially constrained. Nonetheless, if the processor(s) do not find a match for a corresponding segment of the responsive content with respect to a corresponding segment of the plurality of search result documents (or the corresponding portion(s) thereof), the processor(s) can then broaden up the search space to include respective segments of the GM training dataset to ensure proper attribution or modification of the corresponding segment of the responsive content.

In implementations where a corresponding segment of the responsive content matches a corresponding segment of the search result documents or a corresponding segment of the GM training dataset, the processor(s) can attribute or modify at least the corresponding segment of the responsive content to generate modified responsive content, and cause the modified responsive content to be rendered at the client device. Notably, the processor(s) can apply one or more rules in a dynamic manner to attribute or modify at least the corresponding segment of the responsive content to generate the modified responsive content. The one or more rules applied by the processor(s) to attribute or modify at least the corresponding segment of the responsive content to generate the modified responsive content can be based on, for example, source(s) associated with the corresponding segment of the GM training dataset that match the corresponding segment of the responsive content.

However, in implementations where a corresponding segment of the responsive content does not match a corresponding segment of the GM training dataset, the processor(s) can refrain from modifying the corresponding segment of the responsive content and cause the responsive content to be rendered at the client device (e.g., and assuming no other corresponding segment of the responsive content matches a corresponding segment of the GM training dataset).

Although the above implementations are described with respect to initially determining whether a corresponding segment of the responsive content matches a corresponding segment of the additional data and based on the corresponding edit distance therebetween, it should be understood that is for the sake of example to illustrate various techniques contemplated herein and is not meant to be limiting.

For example, in additional or alternative implementations, and prior to receiving the user input, the processor(s) can process, using a hash function, corresponding segments of the GM training dataset to generate and store corresponding hashes for each of the corresponding segments of the GM training dataset. In these implementations, and subsequent to the responsive content being generated but prior to determining whether a corresponding segment of the responsive content matches a corresponding segment of the GM training dataset (or hashes of other additional data described herein), the processor(s) can process, using the hash function, corresponding segments of the responsive content to generate corresponding hashes for each of the corresponding segments of the responsive content. Accordingly, in these implementations, and by using the corresponding hashes, the processor(s) can quickly and efficiently compare the corresponding hashes of the responsive content to the corresponding segments of the GM training dataset (or the hashes of the other additional data described herein) to determine if there is an exact match therebetween since the corresponding hashes provide a computationally efficient manner for these comparisons.

In some versions of these implementations, if there is an exact match between a corresponding segment of the responsive content and a corresponding segment of the GM training dataset (or the other additional data), the processor(s) may not need to determine the corresponding edit distance (e.g., using fuzzy matching as described herein). However, if there is an not exact match between a corresponding segment of the responsive content and a corresponding segment of the GM training dataset (or the other additional data), the processor(s) may determine the corresponding edit distance (e.g., using fuzzy matching as described herein) and utilize the corresponding edit distance to determine whether a corresponding segment of the responsive content matches a corresponding segment of the additional data.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart illustrating an example method of processing a GM training dataset that was utilized to initially train a GM and/or fine-tune the GM, in accordance with various implementations.

FIG. 3 depicts a flowchart illustrating an example method of determining whether to modify responsive content generated using a GM and in response to receiving user input that includes user provided content and a natural language prompt, in accordance with various implementations.

FIG. 4 depicts a flowchart illustrating an example method of determining whether to modify responsive content generated using a GM and in response to receiving user input that initiates a RAG process, in accordance with various implementations.

FIG. 5 depicts a flowchart illustrating an example method of determining whether to modify responsive content generated using a GM and based on a corresponding edit distance between a corresponding segment of responsive content generated using a GM and a corresponding segment of additional data, in accordance with various implementations.

FIG. 6 depicts a flowchart illustrating an example method of determining a corresponding edit distance between a corresponding segment of responsive content generated using a GM and a corresponding segment of additional data, in accordance with various implementations.

FIG. 7 depicts a flowchart illustrating an example method of determining how to modify a corresponding segment of responsive content generated using a GM, in accordance with various implementations.

FIGS. 8A, 8B, 8C, and 8D depict various non-limiting examples of a client device rendering responsive content generated using a GM, in accordance with various implementations.

FIG. 9 depicts an example architecture of a computing device, in accordance with various implementations.

### DETAILED DESCRIPTION OF THE DRAWINGS

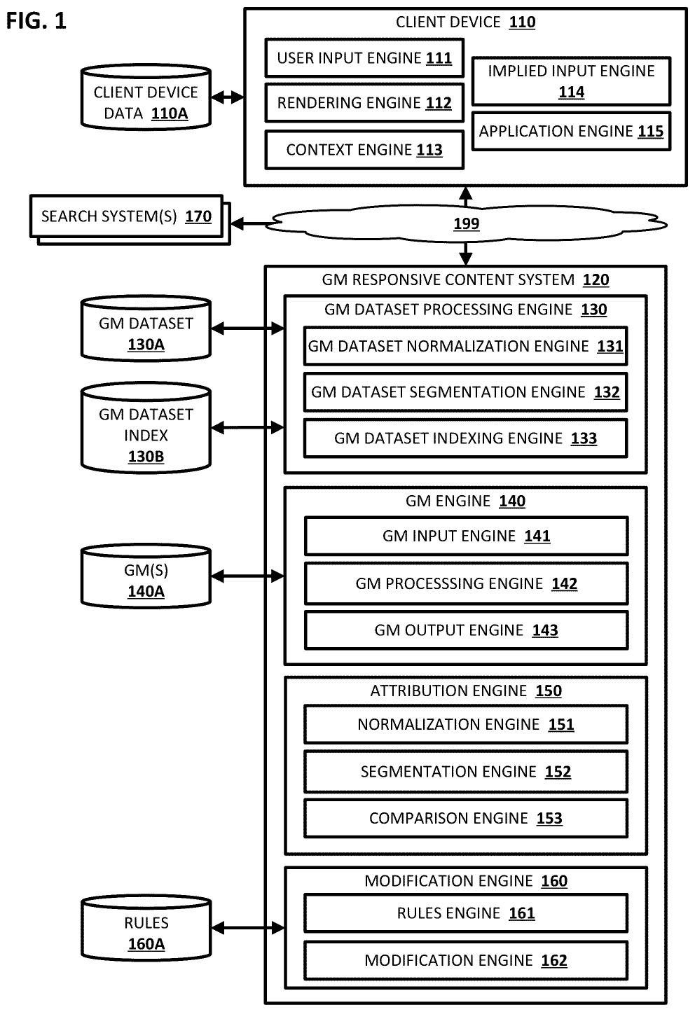

Turning now to FIG. 1, a block diagram of an example environment that demonstrates various aspects of the present disclosure, and in which implementations disclosed herein can be implemented is depicted. The example environment includes a client device 110, a generative model (GM) responsive content system 120, and search system(s) 170. Although illustrated separately, in some implementations, all or aspects of the GM responsive content system 120 can be implemented locally at the client device 110. In additional or alternative implementations, all or aspects of the GM responsive content system 120 can be implemented remotely from the client device 110 as depicted in FIG. 1 (e.g., at remote server(s)). In those implementations, the client device 110 and the GM responsive content system 120 can be communicatively coupled with each other via one or more networks 199, such as one or more wired or wireless local area networks (“LANs,” including Wi-Fi® LANs, mesh networks, Bluetooth®, near-field communication, etc.) or wide area networks (“WANs”, including the Internet). Further, the client device 110 and/or the GM responsive content system 120 can interact with the search system(s) via one or more of the networks 199.

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which user input(s) can be submitted and/or responsive content (e.g., that is responsive to the user input(s)) can be rendered (e.g., audibly and/or visually). The application engine 115 can execute one or more software applications that are separate from an operating system of the client device 110 (e.g., one installed “on top” of the operating system)—or can alternatively be implemented directly by the operating system of the client device 110. For example, the application engine 115 can execute a web browser installed on top of the operating system of the client device 110, or the web browser can be a software application that is integrated as part of the operating system of the client device 110. The application engine 115 (and the one or more software applications executed by the application engine 115) can interact with the GM responsive content system 120, and optionally via a dedicated generative content software application, an automated assistant, or the like.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed input and/or touch input directed to the client device 110.

Some instances of a user input described herein can be a prompt or query for responsive content that is formulated based on user input provided by a user of the client device 110 and detected via user input engine 111. For example, the prompt or query can be a typed prompt or query that is typed via a physical or virtual keyboard, a suggested prompt or query that is selected via a touch screen or a mouse of the client device 110, a spoken voice prompt or voice query that is detected via microphone(s) of the client device 110, or an image prompt or query that is based on an image or video captured by vision component(s) of the client device 110 (or based on a prompt or query generated based on processing the image or video using, for example, object detection model(s), captioning model(s), etc.). Other instances of user input are contemplated herein.

In various implementations, the client device 110 can include a rendering engine 112 that is configured to render responsive content, an indication of source(s) associated with the responsive, and/or other content for audible and/or visual presentation to a user of the client device 110. For example, the client device 110 can be equipped with one or more speakers that enable the responsive content to be provided for audible presentation to the user via the client device 110. Additionally, or alternatively, the client device 110 can be equipped with a display or projector that enables the content to be provided for visual presentation to the user via the client device 110.

In various implementations, the client device 110 can include a context engine 113 that is configured to determine a context (e.g., current or recent context) of the client device 110 and/or of a user of the client device 110 (e.g., an active user of the client device 110 when the client device 110 is associated with multiple users). In some versions of those implementations, the context engine 113 can determine a context based on data stored in client device data database 110A. The data stored in the client device data database 110A can include, for example, user interaction data that characterizes current or recent interaction(s) of the client device 110 and/or of a user of the client device 110, location data that characterizes a current or recent location(s) of the client device 110 and/or of a user of the client device 110, user attribute data that characterizes one or more attributes of a user of the client device 110, user preference data that characterizes one or more preferences of a user of the client device 110, user profile data that characterizes a profile of a user of the client device 110, and/or other data associated with the client device 110 and/or a user of the client device 110.

For example, the context engine 113 can determine a current context based on a current state of a dialog session (e.g., considering one or more recent prompts or queries provided by a user during the dialog session, responsive content provided by the GM responsive content system 120 during the dialog session), profile data, and/or a current location of the client device 110. For instance, the context engine 113 can determine a current context of “visitor looking for popular events in Louisville, Kentucky” based on a recently issued prompt or query, profile data, and an anticipated future location of the client device 110 (e.g., based on recently booked hotel accommodations and/or flight accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting a prompt or query that is formulated based on user input, in generating an implied prompt or implied query (e.g., a query or prompt formulated independent of user input), and/or in determining to submit an implied prompt or implied query and/or to render result(s) (e.g., responsive content) for an implied prompt or implied query.

In various implementations, the client device 110 can include an implied input engine 114 that is configured to: generate an implied prompt or implied query independent of any user input directed to formulating the implied query or the implied prompt; to submit an implied prompt or implied query, optionally independent of any user input that requests submission of the implied prompt or implied query; and/or to cause rendering of search result(s) or a responsive content for an implied prompt or implied query, optionally independent of any user input that requests rendering of the search result(s) or the responsive content. For example, the implied input engine 114 can use one or more past or current contexts, from the context engine 113, in generating an implied prompt or implied query, determining to submit the implied query or the implied prompt, and/or in determining to cause rendering of search result(s) or responsive content that is responsive to the implied query or the implied prompt. For instance, the implied input engine 114 can automatically generate and automatically submit an implied prompt or implied query based on the one or more past or current contexts. Further, the implied input engine 114 can automatically push the search result(s) or the responsive content that is generated responsive to the implied prompt or implied query to cause them to be automatically rendered or can automatically push a notification of the search result(s) or the responsive content, such as a selectable notification that, when selected, causes rendering of the search result(s) or the responsive content. Additionally, or alternatively, the implied input engine 114 can submit the implied query or the implied prompt at regular or non-regular intervals, and cause the search result(s) or the responsive content for the submission(s) to be automatically provided (or a notification thereof automatically provided). For instance, the implied query or the implied prompt can be “patent news” based on the one or more past or current contexts indicating a user's general interest in patents, the implied query or the implied prompt periodically submitted, and the search result(s) or the responsive content can be automatically provided (or a notification thereof automatically provided). It is noted that the provided search result(s) or responsive content result can vary over time in view of, e.g., presence of new/fresh search result document(s) over time.

Further, the client device 110 and/or the GM responsive content system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The GM responsive content system 120 is illustrated in FIG. 1 as including a GM dataset processing engine 130, a GM engine 140, an attribution engine 150, and a modification engine 160. Some of these engines can be combined and/or omitted in various implementations. Further, these engines can include various sub-engines. For instance, the GM dataset processing engine 130 is illustrated in FIG. 1 as including a GM dataset normalization engine 131, a GM dataset segmentation engine 132, and a GM dataset indexing engine 133. Further, the GM engine 140 is illustrated in FIG. 1 as including a GM input engine 141, a GM processing engine 142, and a GM output engine 143. Moreover, the attribution engine 150 is illustrated in FIG. 1 as including a normalization engine 151, a segmentation engine 152, and a comparison engine 153. Lastly, the modification engine 160 is illustrated in FIG. 1 as including a rules engine 161 and a modification engine 162. Similarly, some of these sub-engines can be combined and/or omitted in various implementations. For instance, the GM dataset normalization engine 131 of the GM dataset processing engine 130 and the normalization engine 151 of the attribution engine 150 can be combined, the GM dataset segmentation engine 132 of the GM dataset processing engine 130 and the segmentation engine 152 of the attribution engine 150 can be combined, etc. Accordingly, it should be understood that the various engines and sub-engines of the GM responsive content system 120 illustrated in FIG. 1 are depicted for the sake of clarity and are not meant to be limiting.

Further, the GM responsive content system 120 is illustrated in FIG. 1 as interfacing with various databases, such as a GM dataset database 130A, a GM dataset index database 130B, a GM(s) database 140A, and a rules database 160A. Although particular engines and/or sub-engines are depicted as having access to particular databases, it should be understood that is for the sake of example and is not meant to be limiting. For instance, in some implementations, each of the various engines and/or sub-engines of the GM responsive content system 120 may have access to each of the various databases. However, in some other implementations, one or more of the various databases may be access-restricted.

As described herein, the GM can be any sequence-to-sequence based machine learning models capable of generating generative vision data, generative audio data, generative textual data, and/or other forms of generative data. Some non-limiting examples of these sequence-to-sequence based machine learning models capable that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

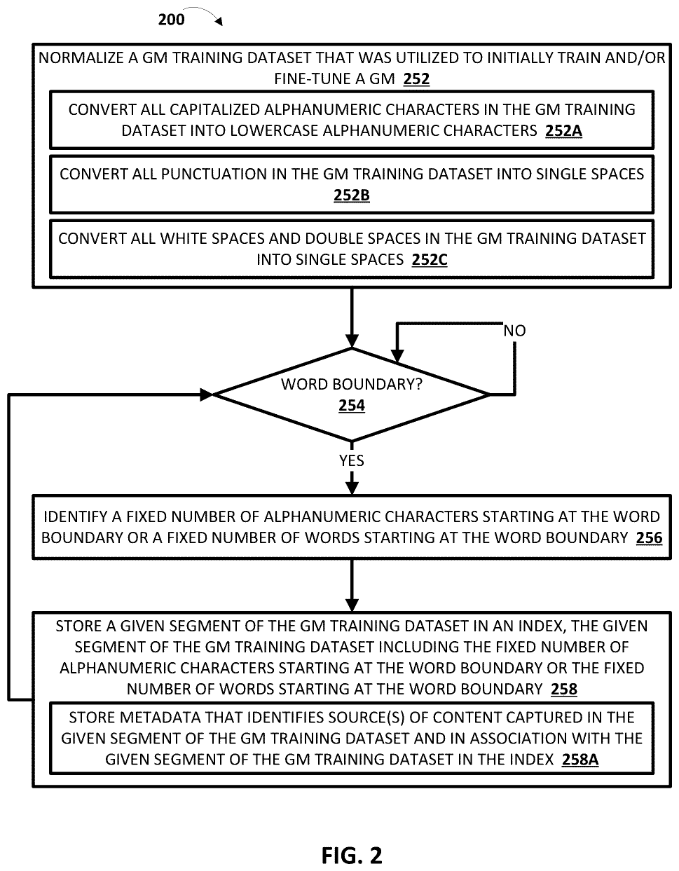

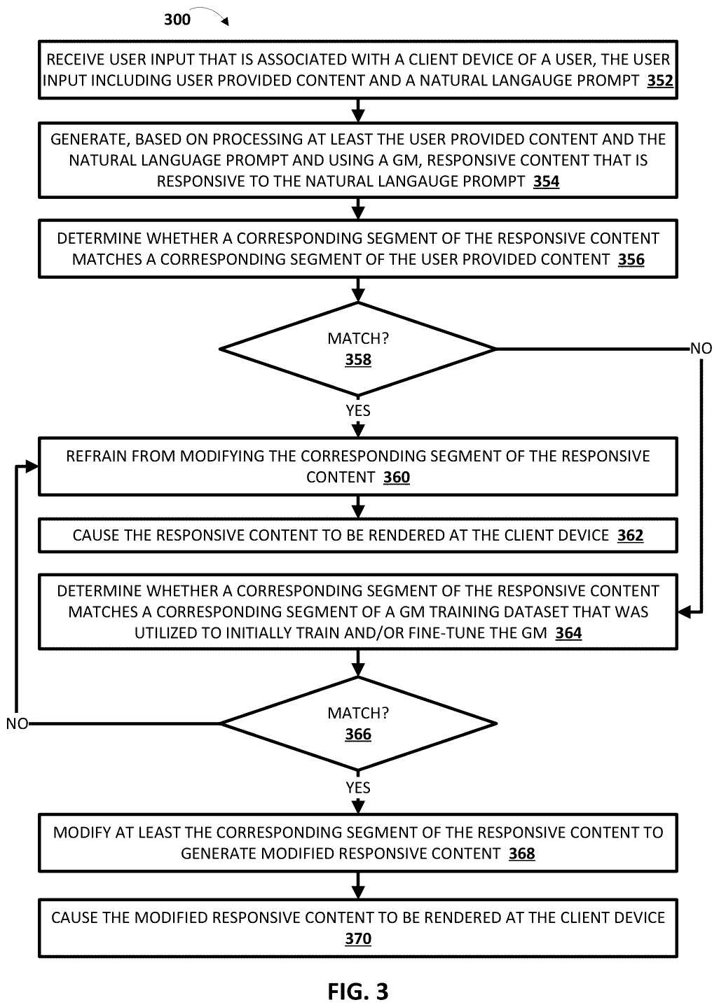

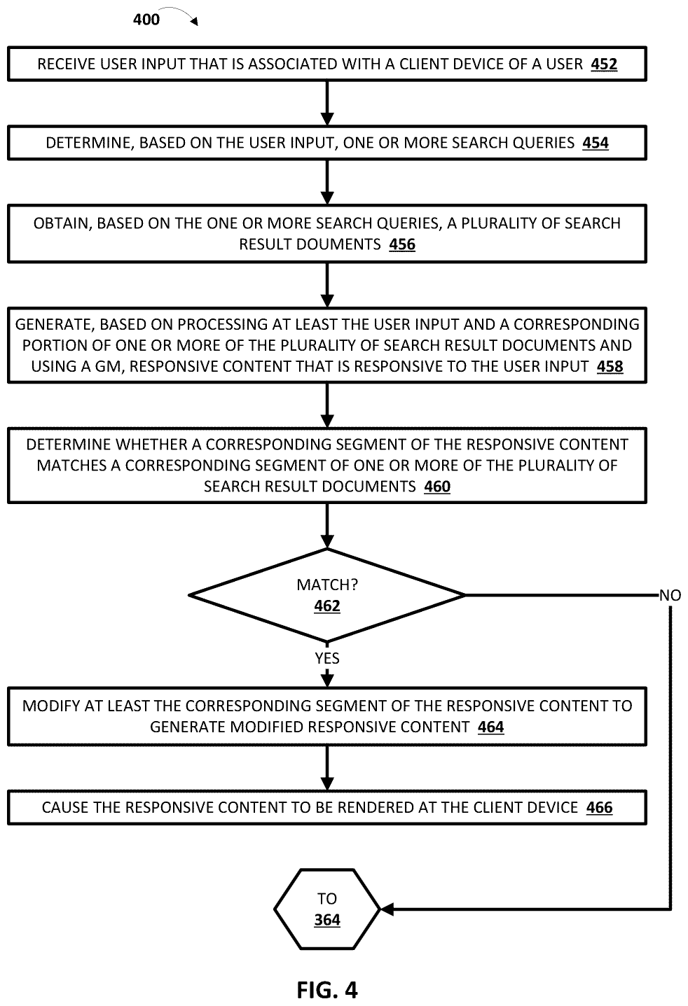

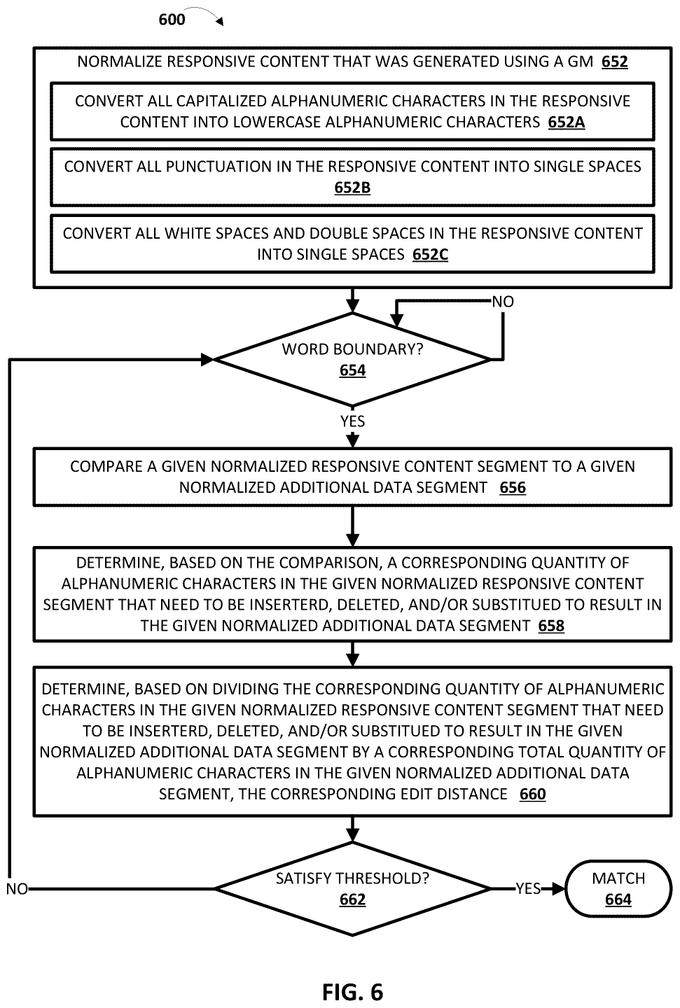

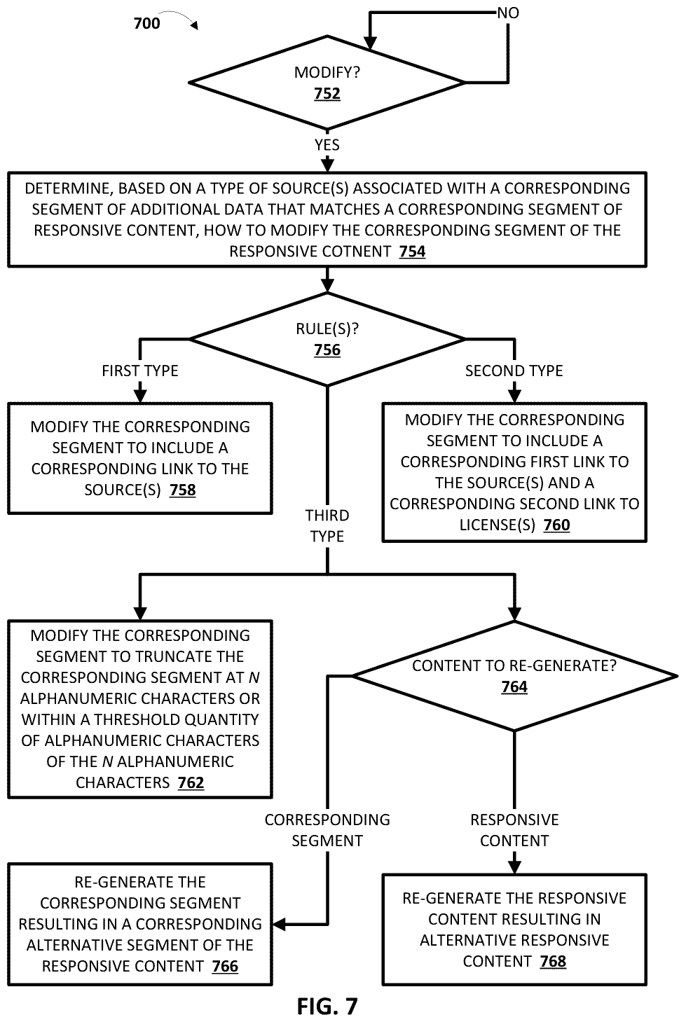

As described in more detail herein (e.g., with respect to FIGS. 2-7), the GM responsive content system 120 can be initially utilized to generate responsive content that is responsive to user input and based on processing at least the user input using the GM. Further, the GM responsive content system 120 can be subsequently utilized to process responsive content, before it is rendered for presentation to a user of the client device 110 that provided the user input, to determine whether to modify segment(s) of the responsive content. In particular, the GM responsive content system 120 can determine whether to modify segment(s) of the responsive content based on whether the segment(s) of the responsive content match segment(s) of additional data. The additional data can include, for example, user provided content (e.g., as described with respect to FIG. 3) that was included as part of the user input and/or implicitly or explicitly referenced by the user input and that was processed using the GM to generate the responsive content, search result documents (e.g., as described with respect to FIG. 4) that were obtained as part of a retrieval augmented generation (RAG) process performed in response to receiving the user input and that were processed using the GM to generate the responsive content, GM training data from a GM training dataset (e.g., as described with respect to FIGS. 3-5) that was utilized to initially train and/or fine-tune the GM and that was normalized, segmented, and indexed (e.g., as described with respect to FIG. 2) prior to the user input being received, and/or other additional data described herein. Notably, in determining whether the segment(s) of the responsive content match the segment(s) of the additional data, the GM responsive content system 120 can determine a corresponding edit distance therebetween and consider the segment(s) of the responsive content to match the segment(s) of the additional data if the corresponding edit distance satisfies an edit distance threshold (e.g., as described with respect to FIG. 6). Further, and assuming that the segment(s) of the responsive content match the segment(s) of the additional data and assuming that at least the segment(s) of the responsive content are to be modified, the GM responsive content system 120 can apply different rules to modify at least the segment(s) of the responsive content based on source(s) of the segment(s) of the additional data (e.g., as described with respect to FIG. 7).

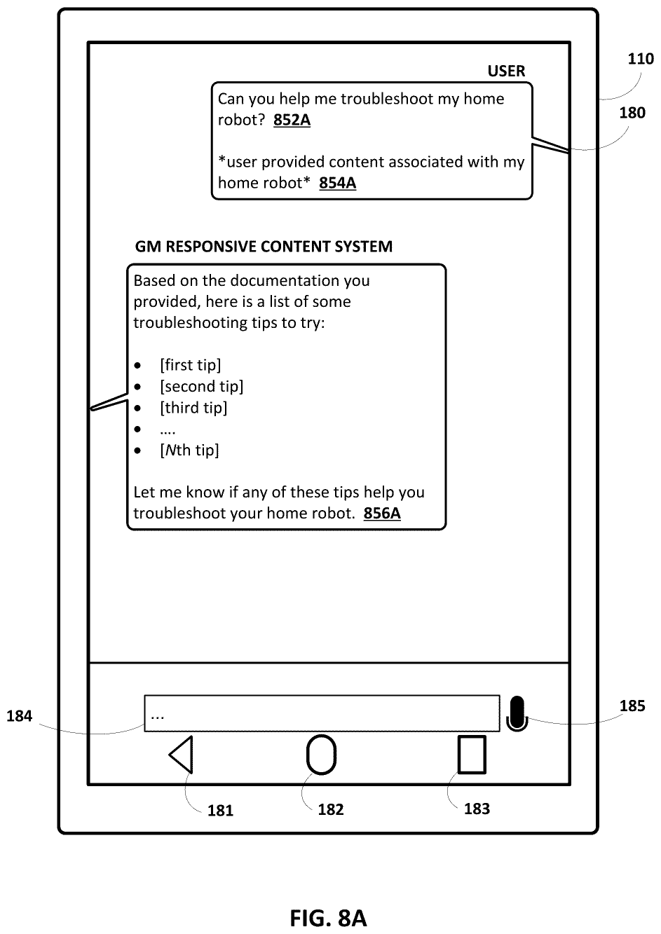

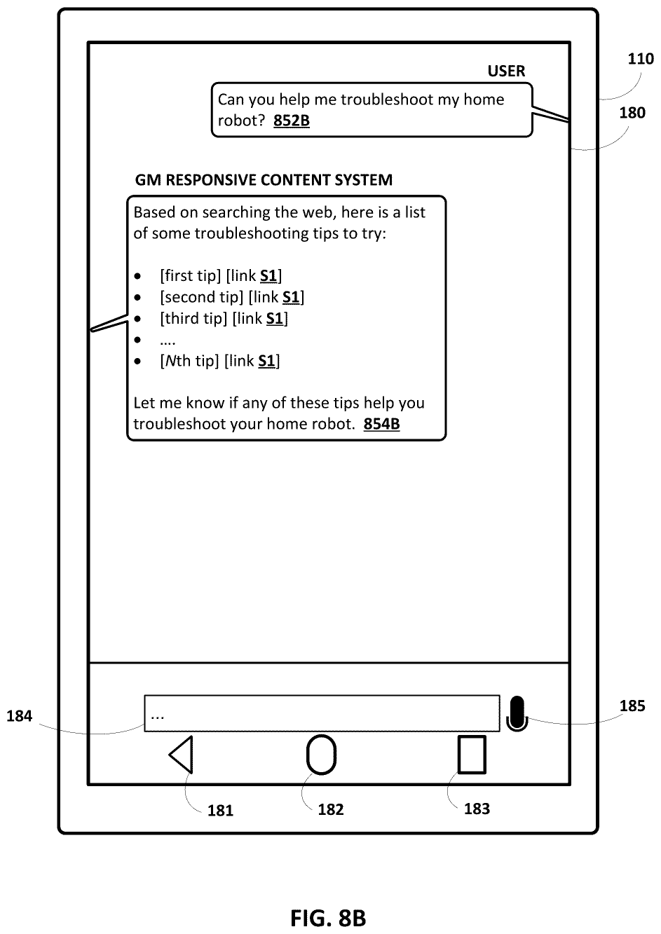

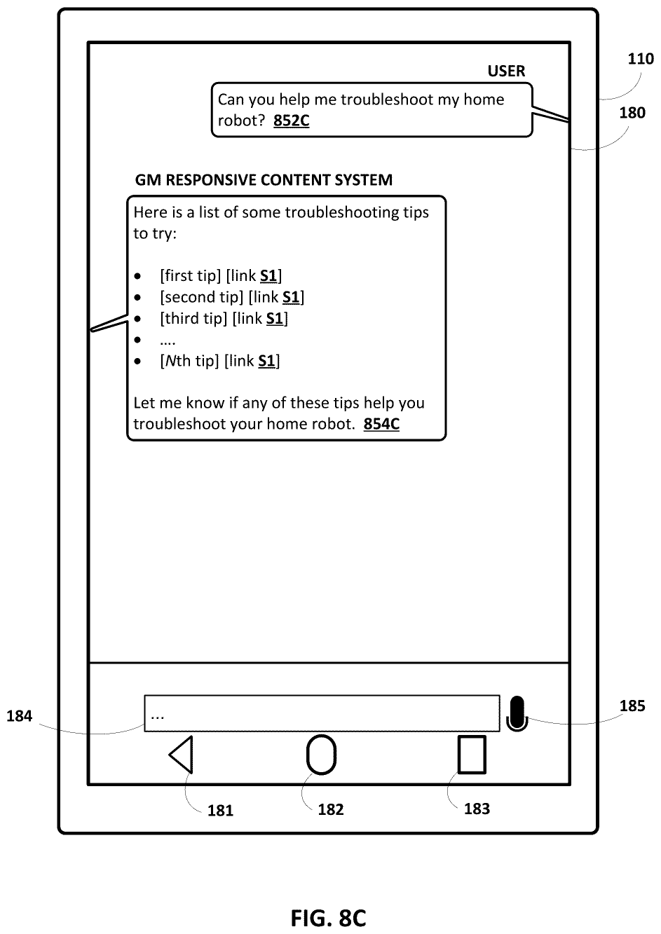

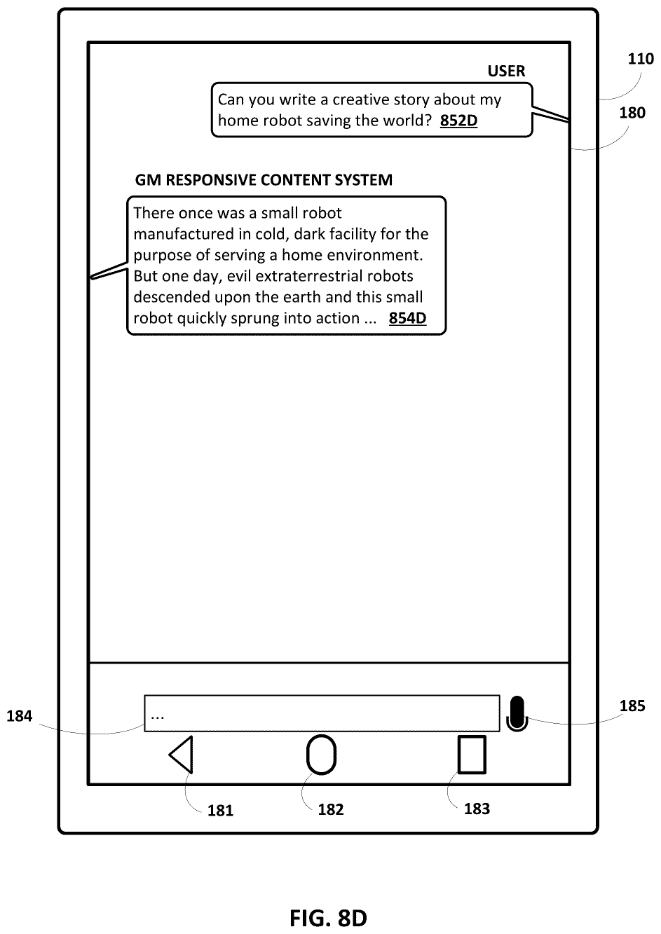

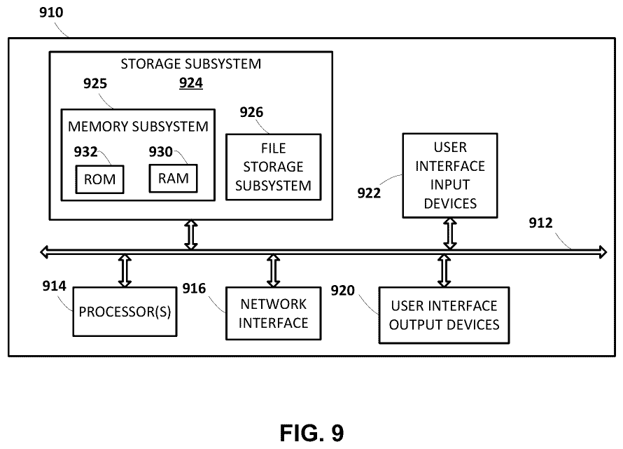

Turning now to FIG. 2, a flowchart illustrating an example method 200 of processing a GM training dataset that was utilized to initially train a GM and/or fine-tune the GM is depicted. For convenience, the operations of the method 200 are described with reference to a system that performs the operations. This system of the method 200 includes one or more processors, memory, and/or other component(s) of computing device(s) (e.g., client device 110 of FIG. 1, GM responsive content system 120 of FIG. 1, client device 810 of FIGS. 8A-8D, computing device 910 of FIG. 9, one or more servers, and/or other computing devices). Moreover, while operations of the method 200 are shown in a particular order, this is not meant to be limiting. One or more operations may be reordered, omitted, and/or added.

At block 252, the system normalizes a GM training dataset (e.g., stored in the GM dataset database 130A) that was utilized to initially train and/or fine-tune a GM. The system can cause the GM dataset normalization engine 131 to process the GM training dataset using various normalization operations to normalize the GM training dataset. For example, at sub-block 252A, the GM dataset normalization engine 131 can convert all capitalized alphanumeric characters in the GM training dataset into lowercase alphanumeric characters. As another example, at sub-block 252B, the GM dataset normalization engine 131 can convert all punctuation in the GM training dataset into single spaces. As yet another example, at sub-block 252C, the GM dataset normalization engine 131 can convert all white spaces and double spaces in the GM training dataset into single spaces. Additional, or alternative, normalization operations are contemplated herein.

Notably, the GM training dataset can include natural language content that may be utilized to initially train and/or fine-tune the GM, such as data from webpages (e.g., public domain webpages, licensed webpages, non-public domain webpages, and/or other webpages), electronic books (e.g., public domain electronic books and/or non-public domain electronic books), electronic documents (e.g., electronic word processing documents, electronic PDFs, etc.), electronic communications (e.g., electronic mail, SMS messages, social media posts or messages), software code (e.g., public domain software code, licensed software code, and/or non-public domain software code), electronic news articles, mathematical formulas, machine translation data, and/or any other data from any other source that can be utilized to train and/or fine-tune the GM. Further, the different sources of the different instances of the GM training dataset may each have different formats. However, by normalizing the GM training dataset, the system can more quickly and efficiently compare segment(s) of responsive content to segment(s) of the GM training dataset. Put another way, the GM dataset normalization engine 131 can implement various normalization operations on the dataset in an “offline” manner prior to receiving any user input to enable the system to subsequently compare segment(s) of the responsive content to segment(s) of the GM training dataset.

At block 254, the system processes alphanumeric characters of the normalized GM dataset to identify a word boundary in the normalized GM training dataset. The system can cause the GM dataset segmentation engine 132 to identify the word boundaries in the normalized GM training dataset. Notably, the word boundary can include any string of alphanumeric characters in the normalized GM training dataset that defines a word. For example, assume that the dataset includes the alphanumeric characters of “prima facie case of patent ineligible subject matter”. In this example, “prima” may correspond to a first word boundary, “facie” may correspond to a second word boundary, “case” may correspond to a third word boundary, and so on. The GM dataset segmentation engine 132 can continually process the normalized GM training dataset to identify word boundaries. If, at an iteration of block 254, the system determines that no word boundary in the normalized GM training dataset has been identified, then the system continues processing the normalized GM training dataset to identify a word boundary at block 254. If, at an iteration of block 254, the system determines that a word boundary has been identified, then the system proceeds to block 256.

At block 256, the system identifies a fixed number of alphanumeric characters starting at the word boundary or a fixed number of words starting at the word boundary. The system can cause the GM dataset segmentation engine 132 to not only identify the word boundary, but also cause GM dataset segmentation engine 132 to identify the fixed number of alphanumeric characters starting at the word boundary or the fixed number of words starting at the word boundary. Notably, the fixed number of alphanumeric characters starting at the word boundary and/or the fixed number of words starting at the word boundary can be a tunable parameter in that can be dynamically adjusted by a developer associated with the system.

At block 258, the system stores a given segment of the GM training dataset in an index, the given segment of the GM training dataset including the fixed number of alphanumeric characters starting at the word boundary or the fixed number of words starting at the word boundary. In some implementations, block 258 includes sub-block 258A in which the system stores metadata that identifies one or more sources of content captured in the given segment of the GM training dataset and in association with the given segment of the GM training dataset in the index. The system can cause the GM dataset indexing engine 133 to store the given segment of the GM training dataset in the index (e.g., the GM dataset index 130B), and optionally in association with an indication of the one or more sources thereof. The system returns to block 254 to process the alphanumeric characters of the normalized dataset to identify an additional word boundary in the normalized dataset. Notably, a quantity of the segments stored in the GM dataset index database 130B can be in the order of hundreds of billions or trillions of segments.

Continuing with the above example where the GM training dataset includes the alphanumeric characters of “prima facie case of patent ineligible subject matter”, further assume that the system utilizes the fixed number of words starting at the word boundary, and further assume that the fixed number of words starting at the words boundary corresponds to six as defined by the developer associated with the system. In this example, a first dataset alphanumeric segment may correspond to “prima facie case of patent ineligible” that starts at the first word boundary of “prima”, a second dataset alphanumeric segment may correspond to “facie case of patent ineligible subject” that starts at the second word boundary of “facie”, a third dataset alphanumeric segment may correspond to “case of patent ineligible subject matter” that starts at the third word boundary of “case”, and so on. Further, the system can store each of the dataset alphanumeric segments in an index.

Further, and continuing with the above example where the GM training dataset includes the alphanumeric characters of “prima facie case of patent ineligible subject matter”, further assume that the alphanumeric characters of “prima facie case of patent ineligible subject matter” are associated with one or more sources. For instance, the alphanumeric characters of “prima facie case of patent ineligible subject matter” may be associated with an electronic document corresponding to the Manual of Patent Examining Procedure (MPEP) that was utilized to initially train and/or fine-tune the GM. Accordingly, in this instance, the alphanumeric characters can be stored in association with metadata that indicates the alphanumeric characters of “prima facie case of patent ineligible subject matter” is derived from the MPEP and optionally include a link (e.g., a uniform resource locator (URL)) to an electronic version of the MPEP.

In various implementations, one or more iterations of the operations of the method 200 of FIG. 2 can be performed in parallel. For instance, the system can continue normalizing the GM training dataset while the system also identifies the word boundaries, identifies the dataset alphanumeric segments, and stores the dataset alphanumeric segments in the index. Further, although the above alphanumeric segments from the above example are described as including six words, it should be understood that is for the sake of example and is not meant to be limiting. Rather, it should be understood that the developer associated with the system (or a developer associated with the third-party) can define different lengths of the alphanumeric segments.

Although the method 200 of FIG. 2 is described with respect to generating the index of the GM training dataset in a particular manner, it should be understood that is for the sake of example to illustrate various techniques contemplated herein, and is not meant to be limiting. For example, in additional or alternative implementations, the system can generate Bloom Filter(s) for the respective segments of the GM training dataset, as opposed to raw strings of the normalized GM training dataset. These Bloom Filter(s) can offer better compression in terms of storage space, and, as a result, can enable the storage of more segments. However, these Bloom Filter(s) may not provide the option for storing the corresponding metadata in association with the segments that includes the source(s) of the content captured in the segments. Thus, these Bloom Filter(s) may add a layer of complexity that is obviated through utilization of the GM dataset index 130B. As another example, in additional or alternative implementations, the system can generate hashes for the respective segments of the GM training dataset and using a hash function, as opposed to raw strings of the normalized GM training dataset. Similar to the aforementioned Bloom Filter(s), these hashes can offer better compression in terms of storage space, and, as a result, can enable the storage of more segments. However, and similar to the aforementioned Bloom Filter(s), these hashes may not provide the option for storing the corresponding metadata in association with the segments that includes the source(s) of the content captured in the segments. Thus, these Bloom Filter(s) may add a layer of complexity that is obviated through utilization of the GM dataset index 130B. Moreover, both the Bloom Filter(s) and hashes may be limited in that they are more conducive to only detecting exact matches and not enable fuzzy matching (e.g., as described with respect to the corresponding edit distance and FIG. 6).

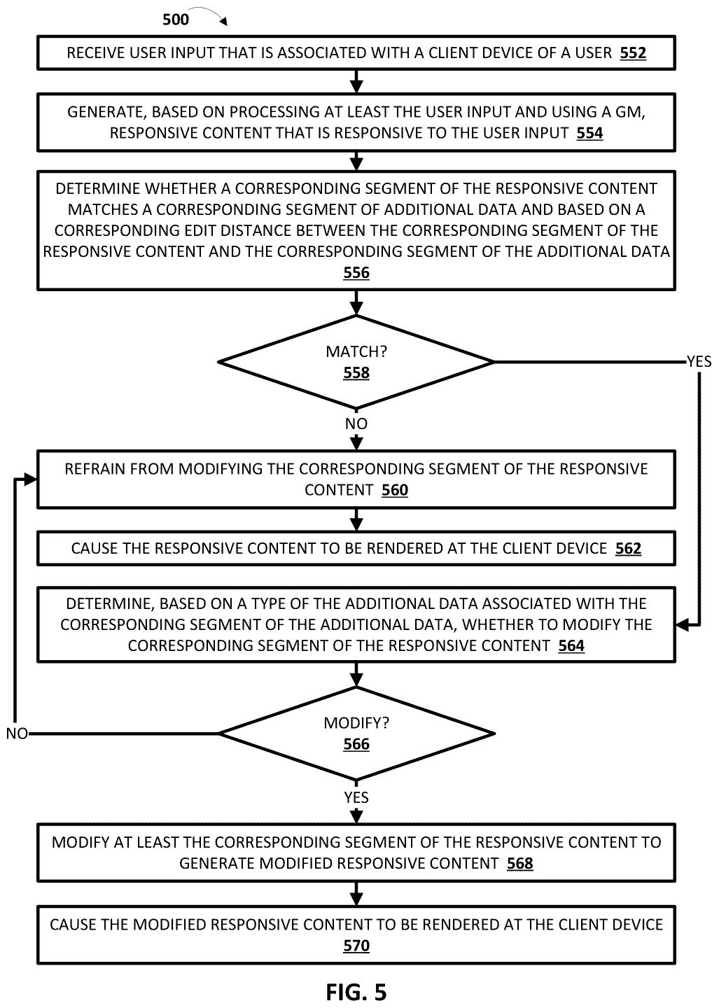

As another example, in additional or alternative implementations, the system can generate a vector for each of the source(s) included in the GM training dataset that was utilized to initially train and/or fine-tune the GM. In some of those implementations, the system can process, using a word2vec algorithm, each of the source(s) to generate a corresponding vector (or embedding) representation thereof, store the corresponding vector representations thereof (e.g., in the GM dataset index 130B), and subsequently utilize the corresponding vector representations in determining whether a corresponding segment of the responsive content matches a corresponding segment of additional data (e.g., as described with respect to FIGS. 5 and 6). The corresponding segment of the additional data can be, for example, a corresponding segment of the GM training dataset, a corresponding segment of user provided content, a corresponding segment of one or more of a plurality of search result documents obtained based on user input, and/or other content. Notably, by using the corresponding vector representations, the system can quickly and efficiently compare these corresponding segments in a lower-level space (e.g., a vector space). In some versions of those implementations, the corresponding vector representations are generated for an entirety of a given source (e.g., a single vector representation for a URL of a web page that was utilized in training the GM). In additional or alternative versions of those implementations, the corresponding vector representations are generated based on the normalized and segmented portions of a given source (e.g., multiple vector representations for a URL of a web page that was utilized in training the GM).

As yet another example, in additional or alternative implementations, the system can generate a bag-of-words (BoW) for each of the source(s) included in the GM training dataset that was utilized to initially train and/or fine-tune the GM. In some of those implementations, the system can process, using a BoW algorithm, each of the source(s) to generate a corresponding BoW representation thereof, store the corresponding BoW representations thereof (e.g., in the GM dataset index 130B), and subsequently utilize the corresponding BoW representations in determining whether a corresponding segment of the responsive content matches a corresponding segment of additional data (e.g., as described with respect to FIGS. 5 and 6). The corresponding segment of the additional data can be, for example, a corresponding segment of the GM training dataset, a corresponding segment of user provided content, a corresponding segment of one or more of a plurality of search result documents obtained based on user input, and/or other content. Notably, by using the corresponding BoW representations, the system can quickly and efficiently compare vocabularies in these corresponding segments. In some versions of those implementations, the corresponding BoW representations are generated for an entirety of a given source (e.g., a single BoW representation for a URL of a web page that was utilized in training the GM). In additional or alternative versions of those implementations, the corresponding BoW representations are generated based on the normalized and segmented portions of a given source (e.g., multiple BoW representations for a URL of a web page that was utilized in training the GM). Additional or alternative natural language processing techniques are contemplated herein.

Turning now to FIG. 3, a flowchart illustrating an example method 300 of determining whether to modify responsive content generated using a GM and in response to receiving user input that includes user provided content and a natural language prompt is depicted. For convenience, the operations of the method 300 are described with reference to a system that performs the operations. This system of the method 300 includes one or more processors, memory, and/or other component(s) of computing device(s) (e.g., client device 110 of FIG. 1, GM responsive content system 120 of FIG. 1, client device 810 of FIGS. 8A-8D, computing device 910 of FIG. 9, one or more servers, and/or other computing devices). Moreover, while operations of the method 300 are shown in a particular order, this is not meant to be limiting. One or more operations may be reordered, omitted, and/or added.

At block 352, the system receives user input that is associated with a client device of a user, the user input including user provided content and a natural language prompt. For instance, the natural language prompt can include typed or spoken input provided by a user of the client device (e.g., detected via the user input engine 111 of the client device 110). In some instances, the user provided content can include content that is explicitly provided by the user and along with the natural language prompt, such as electronic word processing document(s), an electronic PDF(s), electronic books, etc. In other instances, the user provided content can include content that is implicitly provided by the user and referenced by the natural language prompt, such as a corpus of documents or other content which the system can access (e.g., cloud storage), an email account which the system can access, etc.

At block 354, the system generates, based on processing at least the user provided content and the natural language prompt and using a GM, responsive content that is responsive to the natural language prompt. In generating the responsive content that is responsive to the natural language prompt, the system can cause the GM input engine 141 to determine GM input. The GM input can include the user provided content and the natural language prompt, and optionally other contextual information such as a dialog history of an ongoing dialog, system information associated with the system, client device information associated with the client device from which the user input was received, etc. For instance, if the user provided content is an electronic PDF, then the GM input can include optical character recognition (OCR) text for the electronic PDF as opposed to the electronic PDF itself. Put another way, the GM input can be in structured format (e.g., tokenized) that is more suitable for processing by the GM as compared to the raw natural language prompt, the raw user provided content, etc.

Further, the system can cause the GM processing engine 142 to process, using the GM, the GM input to generate GM output. The GM output can include, for example, a probability distribution over a sequence of tokens, such as a probability distribution over a sequence of word units, a sequence of words, a sequence of phrases, or other sequences of tokens. Moreover, the system can cause the GM output engine 143 to determine, based on the probability distribution over the sequence of tokens, the responsive content that is responsive to the natural language prompt. For example, the GM output engine 143 can select word units, word, phrases, or other tokens for inclusion in the responsive content based on the probability distribution over the sequence of tokens and using various decoding techniques (e.g., greedy decoding, beam decoding, sampling decoding, etc.).

At block 356, the system determines whether a corresponding segment of the responsive content matches a corresponding segment of the user provided content. Notably, while the system is generating the responsive content, the system can cause the normalization engine 151 to normalize the user provided content and normalize the natural language prompt and cause the segmentation engine 152 to segment the normalized user provided content and the normalized natural language prompt. For example, and similar to the operations of block 252 of the method 200 of FIG. 2, the normalization engine 151 can: convert all capitalized alphanumeric characters in the user provided content and in the natural language prompt into lowercase alphanumeric characters; convert all punctuation in the user provided content and in the natural language prompt into single spaces; convert all white spaces and double spaces in the user provided content and in the natural language prompt into single spaces; and/or perform other normalization operations. Further, and similar to the operations of blocks 254 and 256 of the method 200 of FIG. 2, the segmentation engine 152 can identify word boundaries in the normalized user provided content and the normalized natural language prompt and can identify a fixed number of alphanumeric characters starting at the word boundaries or a fixed number of words starting at the word boundaries. Moreover, and in subsequent to the system generating the responsive content, the system can cause the normalization engine 151 and the segmentation engine to normalize and segment the responsive content in the same or similar manner.

Notably, this normalization and segmentation enables the system to cause the comparison engine 153 to compare segments of the responsive content to segments of the user provided content to determine whether a corresponding segment of the responsive content matches a corresponding segment of the user provided content. In some implementations, the comparison engine 153 can determine if a corresponding segment of the responsive content is an exact match of a corresponding segment of the user provided content (e.g., based on alphanumeric characters of a corresponding segment of the responsive content being a one-to-one match to alphanumeric characters a corresponding segment of the user provided content). In additional or alternative implementations, the comparison engine 153 can determine if a corresponding segment of the responsive content is a fuzzy match of a corresponding segment of the user provided content (e.g., based on a corresponding edit distance between alphanumeric characters of a corresponding segment of the responsive content and alphanumeric characters of a corresponding segment of the user provided content satisfying an edit distance threshold as described with respect to FIG. 6).

At block 358, if the system determines that a corresponding segment of the responsive content matches a corresponding segment of the user provided content at block 356, then the system proceeds to block 360. At block 360, the system refrains from modifying the corresponding segment of the responsive content. At block 362, the system causes the responsive content to be rendered at the client device. Put another way, if a corresponding segment of the responsive content matches a corresponding segment of the user provided content, then the system determines that there is no need to modify the corresponding segment of the responsive content since a user associated with the client device owns the user provided content, has control over the user provided content, and/or purports to own or otherwise control the user provided content.

Although the operations of blocks 356 and 358 are described with respect to determining whether a corresponding segment of the responsive content matches a corresponding segment of the user provided content, it should be understood that is for the sake of brevity to illustrate techniques contemplated herein and is not meant to be limiting. For example, the system can run multiple instances of the operations of blocks 356 and 358, in parallel, to compare all of the respective segments of the responsive content to all of the respective segments of the user provided content. As another example, the system can run multiple instances of the operations of blocks 356 and 358, in sequence, to compare all of the respective segments of the responsive content to all of the respective segments of the user provided content.

At block 358, if the system determines that a corresponding segment of the responsive content does not match a corresponding segment of the user provided content at block 356, then the system proceeds to block 364. At block 364, the system determines whether a corresponding segment of the responsive content matches a corresponding segment of a GM training dataset that was utilized to initially train and/or fine-tune the GM. Notably, the responsive content was already normalized and segmented (e.g., as described with respect to the operations of blocks 356). Further, the GM training dataset was already normalized, segmented, and stored in an index (e.g., as described with respect to the method 200 of FIG. 2 and stored in the GM dataset index 130B). Accordingly, the system can cause the comparison engine 153 to compare segments of the responsive content to segments of the GM training dataset to determine whether a corresponding segment of the responsive content matches a corresponding segment of the GM training dataset that was utilized to initially train and/or fine-tune the GM. Notably, the comparison engine 153 can determine whether a corresponding segment of the responsive content matches a corresponding segment of the GM training dataset that was utilized to initially train and/or fine-tune the GM in the same or similar manner described above with respect to the operations of block 356, but with respect to the GM training dataset instead of the user provided content.

At block 366, if the system determines that a corresponding segment of the responsive content does not match a corresponding segment of the GM training dataset that was utilized to initially train and/or fine-tune the GM at block 364, then the system returns to block 360. At block 360, the system refrains from modifying the corresponding segment of the responsive content. At block 362, the system causes the responsive content to be rendered at the client device. Put another way, if a corresponding segment of the responsive content does not match a corresponding segment of the GM training dataset, then the system determines that there is no need to modify the corresponding segment of the responsive content since no attribution to source(s) of the GM training dataset is required (e.g., the corresponding segment of the responsive content can be considered original generative content).

At block 366, if the system determines that a corresponding segment of the responsive content matches a corresponding segment of the GM training dataset that was utilized to initially train and/or fine-tune the GM at block 364, then the system proceeds to block 368. At block 368, the system modifies at least the corresponding segment of the responsive content to generate modified responsive content. At block 370, the system causes the modified responsive content to be rendered at the client device 370. The system can cause the rule(s) engine 161 to determine rule(s) to be applied in modifying at least the corresponding segment of the responsive content. Further, the system can cause the modification engine 162 to modify at least the corresponding segment of the responsive content and based on the rule(s) determined using the rule(s) engine 161. Determining the rule(s) to be applied in modifying at least the corresponding segment of the responsive content and modifying at least the corresponding segment of the responsive content and based on the rule(s) is described in more detail herein (e.g., with respect to FIG. 7).

Notably, according to the method 300 of FIG. 3, the system can initially determine whether a corresponding segment of the responsive content matches a corresponding segment of the user provided content, and then determine whether a corresponding segment of the responsive content matches a corresponding segment of the GM training dataset. As noted above with respect to FIG. 2, corresponding segments of the GM training dataset can be in the order of hundreds of billions or trillions of segments.

Accordingly, the system can initially restrict a search space for matching segments of data to the user provided data (e.g., which is orders of magnitude less than the segments of the user provided content) which results in performing a more efficient search and obviating the need for additional processing of the corresponding segment of the responsive content (e.g., for attribution), which conserves computational and/or network resources.

However, it should be understood that is for the sake of example and is not meant to be limiting. As also noted above with respect to FIG. 2, the corresponding segments of the GM training dataset stored in the GM dataset index 130B may be corresponding hashes for the corresponding segments of the GM training dataset that are generated using a hash function. In these implementations, the system may initially determine whether a corresponding segment of the responsive content matches a corresponding segment of the GM training dataset. For example, the system can process, using the hash function, corresponding segments of the responsive content to generate corresponding hashes for the responsive content, and then compare the corresponding hashes for the responsive content to the corresponding hashes for the GM training dataset.

For instance, the system can determine whether a corresponding segment of the responsive content matches a corresponding segment of the GM training dataset prior to executing the operations of block 356. Further, if a corresponding hash of the responsive content matches a corresponding hash of the GM training dataset, then the system can execute the operations of block 356 and proceed with the method 300 (and optionally using hashes for the user provided content in the same or similar manner described above to determine whether there is an exact match and/or using fuzzy matching with respect to the normalized and segmented corresponding segments as described with respect to FIG. 5). However, if no corresponding hash of the responsive content matches a corresponding hash of the GM training dataset, then the system may skip the operations of block 356 and 358, then refrain from modifying the corresponding segment of the responsive content at block 360 and cause the responsive content to be rendered at the client device 362.

While the search space may not be initially restricted in these implementations, processing the responsive content to generate the corresponding hashes of the responsive content to enable comparisons between corresponding segments of the responsive content and corresponding segments of the GM training dataset is computationally efficient compared to, for example, normalizing and segmenting corresponding segments of the responsive content, then comparing the normalized and segmented corresponding segments, thereby balancing utilization of computational resources.

Although the method 300 of FIG. 3 is described with respect to only considering whether a corresponding segment of the responsive content matches a corresponding segment of the user provided content or matches a corresponding segment of the GM training dataset, it should be understood that is for the sake of example and is not meant to be limiting. For instance, the system can additionally, or alternatively, consider whether a corresponding segment of the responsive content matches a corresponding segment of search results documents that are obtained as part of a RAG process and that are processed, using the GM, in generating the responsive content (e.g., as described with respect to FIG. 4).

Turning now to FIG. 4, a flowchart illustrating an example method 400 of determining whether to modify responsive content generated using a GM and in response to receiving user input that initiates a RAG process. For convenience, the operations of the method 400 are described with reference to a system that performs the operations. This system of the method 400 includes one or more processors, memory, and/or other component(s) of computing device(s) (e.g., client device 110 of FIG. 1, GM responsive content system 120 of FIG. 1, client device 810 of FIGS. 8A-8D, computing device 910 of FIG. 9, one or more servers, and/or other computing devices). Moreover, while operations of the method 400 are shown in a particular order, this is not meant to be limiting. One or more operations may be reordered, omitted, and/or added.

At block 452, the system receives user input that is associated with a client device of a user. For instance, the user input can include typed or spoken input provided by a user of the client device (e.g., detected via the user input engine 111 of the client device 110). Put another way, the user input can be a natural language prompt or query.

At block 454, the system determines, based on the user input, one or more search queries. In some implementations, the system can utilize the GM in determining one or more of the search queries. For example, the system can cause the GM input engine 141 to determine GM input. The GM input can include, for example, the user input and an instruction for the GM, or an additional GM (e.g., that includes fewer weights, fewer parameters, etc. as compared to the GM), to generate one or more of the search queries. Notably, the GM input can be in structured format (e.g., tokenized) that is more suitable for processing by the GM, or the additional GM, as compared to the raw user input. Further, the GM processing engine 142 can process, using the GM or the additional GM, the GM input to generate GM output. The GM output can include, for example, a probability distribution over a sequence of tokens (e.g., word units, words, phrases, etc.). Moreover, the GM output engine 143 can determine, based on the GM output, one or more of the search queries. In additional or alternative implementations, one or more of the search queries can be stored in association with one or more terms of the user input, and the system can obtain one or more of the search queries that are stored in association with one or more of the terms of the user input (e.g., via an application programming interface (API)). Notably, in various implementations this process is referred to as RAG, and the GM can be fine-tuned to determine when to initiate a RAG process based on certain user inputs (e.g., that explicitly seek responsive content that is grounded in search result documents, that implicitly seek responsive content that is grounded in search result documents, etc.) and/or based on certain contextual scenarios.

At block 456, the system obtains, based on the one or more search queries, a plurality of search result documents. For example, the GM responsive content system 120 can submit the one or more search queries to the search system(s) 170 to obtain the plurality of search result documents that are responsive to the one or more queries.

As a working example, assume that the user input is “what are the requirements to obtain a patent in the United States”. In this example, the user input is implicitly seeking responsive content that is grounded in search result documents, such as the Manual of Patent Examining Procedure (MPEP). Further, the one or more search queries can include “Title 35 of the United States Code”, “how to obtain a patent in the United States”, “MPEP requirements for obtaining a patent”, or the like that are generated using the GM or stored in association with “patent” in one or more databases. Accordingly, search result documents can be obtained that are responsive to the one or more queries and by leveraging the search system(s) 170.

At block 458, the system generates, based on processing at least the user input and a corresponding portion of one or more of the plurality of search result documents and using a GM, responsive content that is responsive to the user input. In generating the responsive content that is responsive to the user input, the system can cause the GM input engine 141 to determine GM input. The GM input can include the search result documents, or corresponding portions of the search result documents (e.g., snippet(s) from the top N search result documents that are responsive to the one or more queries to reduce a quantity of data that is processed using the GM), and the user input, and optionally other contextual information such as a dialog history of an ongoing dialog, system information associated with the system, client device information associated with the client device from which the user input was received, etc. Continuing with the above working example, if the plurality of search result documents include an electronic copy of the MPEP, then the GM input can include portions of the MPEP that relate to requirements for obtaining a patent (e.g., chapter 2100), rather than the entirety of the electronic copy of the MPEP. Put another way, the GM input can be in structured format (e.g., tokenized) that is more suitable for processing by the GM as compared to the user input, the raw search result documents, etc.

Further, the system can cause the GM processing engine 142 to process, using the GM, the GM input to generate GM output. The GM output can include, for example, a probability distribution over a sequence of tokens, such as a probability distribution over a sequence of word units, a sequence of words, a sequence of phrases, or other sequences of tokens. Moreover, the system can cause the GM output engine 143 to determine, based on the probability distribution over the sequence of tokens, the responsive content that is responsive to the natural language prompt. For example, the GM output engine 143 can select word units, word, phrases, or other tokens for inclusion in the responsive content based on the probability distribution over the sequence of tokens and using various decoding techniques (e.g., greedy decoding, beam decoding, sampling decoding, etc.).

At block 460, the system determines whether a corresponding segment of the responsive content matches a corresponding segment of one or more of the plurality of search result documents. Notably, and similar to the operations of block 356 of the method 300 of FIG. 3, while the system is generating the responsive content, the system can cause the normalization engine 151 to normalize the search results documents (or the corresponding portion(s) thereof) and normalize the user input and cause the segmentation engine 152 to segment the normalized search result documents (or the corresponding portion(s) thereof) and the normalized user input. For example, and similar to the operations of block 252 of the method 200 of FIG. 2, the normalization engine 151 can: convert all capitalized alphanumeric characters in the search results documents (or the corresponding portion(s) thereof) and in the user input into lowercase alphanumeric characters; convert all punctuation in the search results documents (or the corresponding portion(s) thereof) and in the user input into single spaces; convert all white spaces and double spaces in the search results documents (or the corresponding portion(s) thereof) and in the user input into single spaces; and/or perform other normalization operations. Further, and similar to the operations of blocks 254 and 256 of the method 200 of FIG. 2, the segmentation engine 152 can identify word boundaries in the normalized search result documents (or the corresponding portion(s) thereof) and the normalized user input and can identify a fixed number of alphanumeric characters starting at the word boundaries or a fixed number of words starting at the word boundaries. Moreover, and in subsequent to the system generating the responsive content, the system can cause the normalization engine 151 and the segmentation engine to normalize and segment the responsive content in the same or similar manner.

Notably, this normalization and segmentation enables the system to cause the comparison engine 153 to compare segments of the responsive content to segments of the plurality of search result documents (or the corresponding portion(s) thereof) to determine whether a corresponding segment of the responsive content matches a corresponding segment of the plurality of search result documents. In some implementations, the comparison engine 153 can determine if a corresponding segment of the responsive content is an exact match of a corresponding segment of the plurality of search result documents (e.g., based on alphanumeric characters of a corresponding segment of the responsive content being a one-to-one match to alphanumeric characters a corresponding segment of the plurality of search result documents). In additional or alternative implementations, the comparison engine 153 can determine if a corresponding segment of the responsive content is a fuzzy match of a corresponding segment of the plurality of search result documents (e.g., based on a corresponding edit distance between alphanumeric characters of a corresponding segment of the responsive content and alphanumeric characters of a corresponding segment of the plurality of search result documents satisfying an edit distance threshold as described with respect to FIG. 6).

At block 462, if the system determines that a corresponding segment of the responsive content matches a corresponding segment of the user provided content at block 460, then the system proceeds to block 464. At block 464, the system modifies at least the corresponding segment of the responsive content to generate modified responsive content. At block 466, the system causes the responsive content to be rendered at the client device. The system can cause the rule(s) engine 161 to determine rule(s) to be applied in modifying at least the corresponding segment of the responsive content. Further, the system can cause the modification engine 162 to modify at least the corresponding segment of the responsive content and based on the rule(s) determined using the rule(s) engine 161. Determining the rule(s) to be applied in modifying at least the corresponding segment of the responsive content and modifying at least the corresponding segment of the responsive content and based on the rule(s) is described in more detail herein (e.g., with respect to FIG. 7).

At block 462, if the system determines that a corresponding segment of the responsive content does not match a corresponding segment of the user provided content at block 460, then the system proceeds to block 364 from the method 300 of FIG. 3 and continues with the method 300 of FIG. 3. Put another way, the system can initially determine whether a corresponding segment of the responsive content matches a corresponding segment of the plurality of search result documents (e.g., based on the operations of blocks 460 and 462 of the method 400 of FIG. 4), and then determine whether a corresponding segment of the responsive content matches a corresponding segment of the GM training dataset (e.g., based on the operations of blocks 364 and 366 of the method 300 of FIG. 3). As noted above with respect to FIG. 2, corresponding segments of the GM training dataset can be in the order of hundreds of billions or trillions of segments.

Accordingly, the system can initially restrict a search space for matching segments of data to the plurality of search result documents (e.g., which is orders of magnitude less than the segments of the user provided content) which results in performing a more efficient search. However, in contrast with the method 300 of FIG. 3 where a corresponding segment of the responsive content is not modified if it matches a corresponding segment of user provided content, a corresponding segment of the responsive content is modified if it matches a corresponding segment of the plurality of search result documents. Nonetheless, the method 400 of FIG. 4 can obviate the need for additional searching (e.g., across the GM training dataset) if a corresponding segment of the responsive content matches a corresponding segment of the plurality of search result documents, which conserves computational and/or network resources.

However, it should be understood that is for the sake of example and is not meant to be limiting. As also noted above with respect to FIG. 2, the corresponding segments of the GM training dataset stored in the GM dataset index 130B may be corresponding hashes for the corresponding segments of the GM training dataset that are generated using a hash function. In these implementations, the system may initially determine whether a corresponding segment of the responsive content matches a corresponding segment of the GM training dataset. For example, the system can process, using the hash function, corresponding segments of the responsive content to generate corresponding hashes for the responsive content, and then compare the corresponding hashes for the responsive content to the corresponding hashes for the GM training dataset.

For instance, the system can determine whether a corresponding segment of the responsive content matches a corresponding segment of the GM training dataset prior to executing the operations of block 460. Further, if a corresponding hash of the responsive content matches a corresponding hash of the GM training dataset, then the system can skip the operations of blocks 460 and 462, then modify at least the corresponding segment of the responsive content to generate the modified responsive content at block 464 and cause the responsive content to be rendered at block 466. However, if no corresponding hash of the responsive content matches a corresponding hash of the GM training dataset, then the system may execute the operations of block 460 and proceed with the method 400 (and optionally using hashes for the user provided content in the same or similar manner described above to determine whether there is an exact match and/or using fuzzy matching with respect to the normalized and segmented corresponding segments as described with respect to FIG. 5).

While the search space may not be initially restricted in these implementations, processing the responsive content to generate the corresponding hashes of the responsive content to enable comparisons between corresponding segments of the responsive content and corresponding segments of the GM training dataset is computationally efficient compared to, for example, normalizing and segmenting corresponding segments of the responsive content, then comparing the normalized and segmented corresponding segments, thereby balancing utilization of computational resources.

Although the operations of blocks 460 and 462 are described with respect to determining whether a corresponding segment of the responsive content matches a corresponding segment of the plurality of search result documents, it should be understood that is for the sake of brevity to illustrate techniques contemplated herein and is not meant to be limiting. For example, the system can run multiple instances of the operations of blocks 460 and 462, in parallel, to compare all of the respective segments of the responsive content to all of the respective segments of the plurality of search result documents. As another example, the system can run multiple instances of the operations of blocks 460 and 462, in sequence, to compare all of the respective segments of the responsive content to all of the respective segments of the plurality of search result documents.

Further, although the method 400 of FIG. 4 is described with respect to only considering whether a corresponding segment of the responsive content matches a corresponding segment of the plurality of search result documents or matches a corresponding segment of the GM training dataset, it should be understood that is for the sake of example and is not meant to be limiting. For instance, the system can additionally, or alternatively, consider whether a corresponding segment of the responsive content matches a corresponding segment of user provided content that is in addition to a natural language prompt included in the user input (e.g., as described with respect to FIG. 3).

Turning now to FIG. 5, a flowchart illustrating an example method 500 of determining whether to modify responsive content generated using a GM and based on a corresponding edit distance between a corresponding segment of responsive content generated using a GM and a corresponding segment of additional data is depicted. For convenience, the operations of the method 500 are described with reference to a system that performs the operations. This system of the method 500 includes one or more processors, memory, and/or other component(s) of computing device(s) (e.g., client device 110 of FIG. 1, GM responsive content system 120 of FIG. 1, client device 810 of FIGS. 8A-8D, computing device 910 of FIG. 9, one or more servers, and/or other computing devices). Moreover, while operations of the method 500 are shown in a particular order, this is not meant to be limiting. One or more operations may be reordered, omitted, and/or added.

At block 552, the system receives user input that is associated with a client device of a user. For instance, the user input can include typed or spoken input provided by a user of the client device (e.g., detected via the user input engine 111 of the client device 110). Put another way, the user input can be a natural language prompt or query.

At block 554, the system generates, based on processing at least the user input and using a GM, responsive content that is responsive to the user input. In generating the responsive content that is responsive to the user input, the system can cause the GM input engine 141 to determine GM input. The GM input can include the user input, and optionally other contextual information such as a dialog history of an ongoing dialog, system information associated with the system, client device information associated with the client device from which the user input was received, etc. Further, the system can cause the GM processing engine 142 to process, using the GM, the GM input to generate GM output. The GM output can include, for example, a probability distribution over a sequence of tokens, such as a probability distribution over a sequence of word units, a sequence of words, a sequence of phrases, or other sequences of tokens. Moreover, the system can cause the GM output engine 143 to determine, based on the probability distribution over the sequence of tokens, the responsive content that is responsive to the natural language prompt.

Although the method 500 of FIG. 5 is not described with respect to the GM input including user provided content as in the method 300 of FIG. 3 and/or a plurality of search result documents (or corresponding portion(s) thereof) as in the method 400 of FIG. 4, it should be understood that is for the sake of brevity and is not meant to be limiting. Rather, it should be understood that the GM input in the method 500 of FIG. 5 may additionally, or alternatively, include the user provided content as in the method 300 of FIG. 3 and/or the plurality of search result documents (or the corresponding portion(s) thereof) as in the method 400 of FIG. 4.

At block 556, the system determines whether a corresponding segment of the responsive content matches a corresponding segment of additional data and based on a corresponding edit distance between the corresponding segment of the responsive content and the corresponding segment of the additional data. The additional data can include, for example, user provided content that was included as part of the user input and/or implicitly or explicitly referenced by the user input and that was processed using the GM to generate the responsive content (e.g., as described with respect to the method 300 of FIG. 3), search result documents that were obtained as part of a RAG process performed in response to receiving the user input and that were processed (or corresponding portion(s) thereof were processed) using the GM to generate the responsive content (e.g., as described with respect to the method 400 of FIG. 4), GM training data from a GM training dataset that was utilized to initially train and/or fine-tune the GM (e.g., as described with respect to the method 200 of FIG. 2 and the method 300 of FIG. 3). Determining the corresponding edit distance is described in more detail herein (e.g., with respect to FIG. 6).

In some implementations, the system can cause the additional data to be normalized and segmented while the responsive content is being generated. For example, as described with respect to the operations of blocks 356 and 358 of the method 300 of FIG. 3, any user provided content can be normalized and segmented while the responsive content is being generated (e.g., using the normalization engine 151 and the segmentation engine 152). As another example, as described with respect to the operations of blocks 460 and 462 of the method 400 of FIG. 4, any search result documents can be normalized and segmented while the responsive content is being generated (e.g., using the normalization engine 151 and the segmentation engine 152). This parallelized processing can reduce latency in causing further processing of the responsive content from being performed and, as a result, reduces latency in causing the responsive content (or modified responsive content or alternative responsive content) to be rendered at the client device associated with the user. In additional or alternative implementations, the system can cause the additional data to be normalized and segmented before the user input is received. For example, as described with respect to the method 200 of FIG. 2, the GM training dataset can be normalized, segmented, and indexed (e.g., in the GM dataset index 130B) prior to receiving the user input (e.g., using the GM dataset normalization engine 131, the GM dataset segmentation engine 132, and the GM dataset indexing engine 133). In various implementations, the system can cause the responsive content to be normalized and segmented subsequent to the responsive content being generated (e.g., in the same or similar manner described with respect to the method 300 of FIG. 3 and the method 400 of FIG. 4).

At block 558, if the system determines that a corresponding segment of the responsive content does not match a corresponding segment of the additional data at block 556, then the system proceeds to block 560. At block 560, the system refrains from modifying the corresponding segment of the responsive content. At block 562, the system causes the responsive content to be rendered at the client device. Put another way, if a corresponding segment of the responsive content does not match a corresponding segment of the additional data, then the system determines that there is no need to modify the corresponding segment of the responsive content since no attribution to source(s) of the additional data is required (e.g., the corresponding segment of the responsive content can be considered original generative content).

At block 558, if the system determines that a corresponding segment of the responsive content matches a corresponding segment of the additional data at block 556, then the system proceeds to block 564. At block 564, the system determines, based on a type of the additional data associated with the corresponding segment of the additional data, whether to modify the corresponding segment of the responsive content. Notably, if the type of the additional data associated with the corresponding segment of the additional data that matches the corresponding segment of the responsive content is a certain type, then the corresponding segment of the responsive content may not necessarily need to be modified. For example, if the type of the additional data associated with the corresponding segment of the additional data that matches the corresponding segment of the responsive content is user provided content, then the system may not attribute the corresponding segment of the responsive content to the user provided content (e.g., as described with respect to the method 300 of FIG. 3). However, if the type of the additional data associated with the corresponding segment of the additional data that matches the corresponding segment of the responsive content is a different type, then the corresponding segment of the responsive content may not necessarily need to be modified. For example, if the type of the additional data associated with the corresponding segment of the additional data that matches the corresponding segment of the responsive content is search result documents (e.g., obtained using a RAG process) or GM training data included in a GM training dataset, then the system may attribute the corresponding segment of the responsive content to the user provided content (e.g., as described with respect to the method 300 of FIG. 3 and the method 400 of FIG. 4).

Although the operations of blocks 556 and 558 are described with respect to determining whether a corresponding segment of the responsive content matches a corresponding segment of the additional data, it should be understood that is for the sake of brevity to illustrate techniques contemplated herein and is not meant to be limiting. For example, the system can run multiple instances of the operations of blocks 556 and 558, in parallel, to compare all of the respective segments of the responsive content to all of the respective segments of the additional data. As another example, the system can run multiple instances of the operations of blocks 556 and 558, in sequence, to compare all of the respective segments of the responsive content to all of the respective segments of the additional data (e.g., for different types of additional data in a progressive manner).

At block 566, if the system determines not to modify the corresponding segment of the response content based on the type of the additional data associated with the corresponding segment of the additional data at block 564, the system returns to block 560. At block 560, the system refrains from modifying the corresponding segment of the responsive content. At block 562, in implementations where the, the system causes the responsive content to be rendered at the client device. Put another way, in implementations where the system determines the type of the additional data associated with the corresponding segment of the additional data is of a certain type (e.g., user provided content), the system determines that there is no need to modify the corresponding segment of the responsive content since a user associated with the client device owns the user provided content, has control over the user provided content, and/or purports to own or otherwise control the user provided content.

At block 566, if the system determines to modify the corresponding segment of the response content based on the type of the additional data associated with the corresponding segment of the additional data at block 564, the system proceeds to block 568. At block 568, the system modifies at least the corresponding segment of the responsive content to generate modified responsive content. At block 570, the system causes the modified responsive content to be rendered at the client device. The system can cause the rule(s) engine 161 to determine rule(s) to be applied in modifying at least the corresponding segment of the responsive content. Further, the system can cause the modification engine 162 to modify at least the corresponding segment of the responsive content and based on the rule(s) determined using the rule(s) engine 161. Determining the rule(s) to be applied in modifying at least the corresponding segment of the responsive content and modifying at least the corresponding segment of the responsive content and based on the rule(s) is described in more detail herein (e.g., with respect to FIG. 7).

Notably, in the method 500 of FIG. 5, the system can progressively check whether a corresponding segment of the response content matches a corresponding segment of the additional data. For instance, the system can initially determine whether a corresponding segment of the response content matches a corresponding segment of user provided content (if any) that is provided by the user and that is processed in generating the responsive content. If a corresponding segment of the response content matches a corresponding segment of the user provided content, then the system need not check whether the corresponding segment of the response content matches other additional data (e.g., portion(s) of search result documents obtained using a RAG progress, GM training data included in a GM training dataset, and/or other types of additional data), thereby obviating a need for further processing of the corresponding segment of the responsive content and/or modification of the corresponding segment of the responsive content. Subsequently, the system can determine whether a corresponding segment of the response content matches a corresponding segment of search result documents (if any) that are obtained using a RAG process and that are processed in generating the responsive content. If a corresponding segment of the response content matches a corresponding segment of the search result documents, then the system need not check whether the corresponding segment of the response content matches other additional data (e.g., GM training data included in a GM training dataset and/or other types of additional data), thereby obviating a need for further processing of the corresponding segment of the responsive content (e.g., relative to the GM training dataset). Lastly, the system can determine whether a corresponding segment of the response content matches a corresponding segment of a GM training dataset that was utilized to initially train and/or fine-tune the GM. In these and other manners herein, this progressive analysis can balance consumption of computational resources while enforcing proper attribution to the additional data as desired.

However, it should be understood that is for the sake of example and is not meant to be limiting. As also noted above with respect to FIG. 2, the corresponding segments of the GM training dataset stored in the GM dataset index 130B may be corresponding hashes for the corresponding segments of the GM training dataset that are generated using a hash function. In these implementations, the system may initially determine whether a corresponding segment of the responsive content matches a corresponding segment of the GM training dataset. For example, the system can process, using the hash function, corresponding segments of the responsive content to generate corresponding hashes for the responsive content, and then compare the corresponding hashes for the responsive content to the corresponding hashes for the GM training dataset.

For instance, the system can determine whether a corresponding segment of the responsive content is an exact match to a corresponding segment of the additional data prior to executing the operations of block 556. Further, if a corresponding hash of the responsive content matches a corresponding hash of the additional data (e.g., the GM training dataset, any user provided content, and search result document(s) obtained using a RAG process), then the system can skip the operations of block 564 and continue with the method 500. However, if no corresponding hash of the responsive content matches a corresponding hash of the additional data, then the system may execute the operations of block 556 and continue with the method 500.

Turning now to FIG. 6, a flowchart illustrating an example method 600 of determining a corresponding edit distance between a corresponding segment of responsive content generated using a GM and a corresponding segment of additional data is depicted. For convenience, the operations of the method 600 are described with reference to a system that performs the operations. This system of the method 600 includes one or more processors, memory, and/or other component(s) of computing device(s) (e.g., client device 110 of FIG. 1, GM responsive content system 120 of FIG. 1, client device 810 of FIGS. 8A-8D, computing device 910 of FIG. 9, one or more servers, and/or other computing devices). Moreover, while operations of the method 600 are shown in a particular order, this is not meant to be limiting. One or more operations may be reordered, omitted, and/or added.

At block 652, the system normalizes responsive content that was generated using a GM. The system can cause the normalization engine 151 to process the responsive content using various normalization operations to normalize the responsive content. For example, at sub-block 652A, the normalization engine 151 can convert all capitalized alphanumeric characters in the responsive content into lowercase alphanumeric characters. As another example, at sub-block 652B, the normalization engine 151 can convert all punctuation in the responsive content into single spaces. As yet another example, at sub-block 652C, the normalization engine 151 can convert all white spaces and double spaces in the responsive content into single spaces. Additional, or alternative, normalization operations are contemplated herein.

At block 654, the system processes alphanumeric characters of the normalized responsive content to identify a word boundary in the normalized GM responsive content. The system can cause the segmentation engine 152 to identify the word boundaries in the normalized responsive content. Notably, the word boundary can include any string of alphanumeric characters in the normalized responsive content that defines a word. The segmentation engine 152 can continually process the normalized responsive content to identify word boundaries. If, at an iteration of block 654, the system determines that no word boundary in the normalized responsive content has been identified, then the system continues processing the normalized responsive content to identify a word boundary at block 654. If, at an iteration of block 654, the system determines that a word boundary has been identified, then the system proceeds to block 656.

At block 656, the system compares a given normalized responsive content segment to a given normalized additional data segment. At block 658, the system determines, based on the comparison, a corresponding quantity of alphanumeric characters in the given normalized responsive content segment that need to be inserted, deleted, and/or substituted to result in the given normalized additional data segment. At block 660, the system determines, based on dividing the corresponding quantity of alphanumeric characters in the given normalized responsive content segment that need to be inserted, deleted, and/or substituted to result in the given normalized additional data segment by a corresponding total quantity of alphanumeric characters in the given normalized additional data segment, the corresponding edit distance.

For example, the system can cause the comparison engine 153 to compare the given normalized responsive content segment to the given normalized additional data segment on an alphanumeric character by alphanumeric character basis. Based on comparing the given normalized responsive content segment to the given normalized additional data segment on the alphanumeric character by alphanumeric character basis, the comparison engine can determine the corresponding quantity of alphanumeric characters in the given normalized responsive content segment that need to be inserted, deleted, and/or substituted to result in the given normalized additional data segment.

For instance, assume that the given normalized additional data segment is “organize the worlds information and make it universally accessible and useful”. Further assume that the given normalized responsive content segment is “organize the worlds information and make it universally accessible and useful”. In this instance, the corresponding total quantity of alphanumeric characters in the given normalized additional data segment is 80, but no alphanumeric characters in the given normalized responsive content segment that need to be inserted, deleted, and/or substituted to result in the given normalized additional data segment. Accordingly, the corresponding edit distance is 0.0 and the given normalized responsive content segment is an exact match to the given normalized additional data segment.

Also, for instance, again assume that the given normalized additional data segment is “organize the worlds information and make it universally accessible and useful”. However, assume that the given normalized responsive content segment is “organizing the worlds information and make it universally accessible and useful”. In this instance, the corresponding total quantity of alphanumeric characters in the given normalized additional data segment is still 80, but 3 alphanumeric characters in the given normalized responsive content segment that need to be inserted, deleted, and/or substituted to result in the given normalized additional data segment (e.g., the difference between “organize” and “organizing” for substituting “e” with “ing”). Accordingly, the corresponding edit distance is 0.0375 (e.g., the 3 alphanumeric characters in the given normalized responsive content segment that need to be substituted divided by the 80 total alphanumeric characters in the given normalized additional data segment).

At block 662, the system determines whether the corresponding edit distance between the given normalized responsive content segment and the given normalized additional data segment satisfies an edit distance threshold. The system can cause the comparison engine 153 to compare the corresponding edit distance to the edit distance threshold to determine whether the corresponding edit distance satisfies the edit distance threshold. The edit distance threshold can be, for example, a tunable parameter that is tunable by a developer associated with the system.

If, at an iteration of block 662, the system determines that the corresponding edit distance between the given normalized responsive content segment and the given normalized additional data segment fails to satisfy the edit distance threshold, then the system returns to block 654 to continue with an additional iteration of the method 600 of FIG. 6. For instance, the system can continue identifying word boundaries and comparing respective instances of the normalized responsive content segments with respective instances of the normalized additional data segments to determine whether they match. Notably multiple instances of the operations of blocks 654-662 can be performed in a parallel manner, in a sequential manner, and/or in a combination of a parallel manner and sequential manner.

If, at an iteration of block 662, the system determines that the corresponding edit distance between the given normalized responsive content segment and the given normalized additional data segment satisfies the edit distance threshold, then the system determines that the given normalized responsive content segment matches the given normalized additional data segment as indicated at 664. Notably, the method 600 of FIG. 6 can be utilized to determine whether a corresponding segment of the responsive content matches a corresponding segment of additional data at any one of the operations of blocks 356 and 358 of the method 300 of FIG. 3, the operations of blocks 364 and 366 of the method 300 of FIG. 3, the operations of blocks 460 and 462 of the method 400 of FIG. 4, the operations of blocks 556 and 558 of the method 500 of FIG. 5, and/or in other similar determinations described herein.

Although the method 600 of FIG. 6 is described with respect to utilizing the edit distance between the corresponding segment of the responsive content and the corresponding segment of the additional data to determine whether there is a match therebetween, it should be understood that is for the sake of example and is not meant to be limiting. For example, and as described with respect to the method 200 of FIG. 2, the system can utilize corresponding vector (or embedding) representations of the corresponding segment of the responsive content and the corresponding segment of the additional data to determine whether there is a match therebetween, can utilize corresponding BoW representations of the corresponding segment of the responsive content and the corresponding segment of the additional data to determine whether there is a match therebetween, and/or can utilize other natural language processing techniques to determine whether there is match therebetween.

For example, assume that the additional data is user provided content that is received along with a natural language prompt as described with respect to the method 300 of FIG. 3. In this example, the system can generate the corresponding vector (or embedding) representations of the user provided content, the corresponding BoW representations of the user provided content, etc. in response to the user provided content being provided to the system (and optionally after the user has provided the user provided content, but before a user finishes providing the natural language prompt). Further, the system can generate the corresponding vector (or embedding) representations of the responsive content, the corresponding BoW representations of the responsive content, etc. in response to the responsive content being generated. This parallelization can have no or little impact on latency in causing the responsive content being provided for presentation to the user, and can be more robust when compared to only considering corresponding hashes of the corresponding segments and/or when compared to only considering the corresponding edit distance between the corresponding segments. Moreover, and in comparing these corresponding representations of the responsive content to the corresponding representations of the user provided content, the system can employ a cosine similarity algorithm or another distance-based matching algorithm to determine whether there is a match therebetween (e.g., if the similarity therebetween satisfies a threshold) and can adapt any subsequent processing based on that determination as described herein.

As another example, assume that the additional data is a corresponding portion of one or more of a plurality of search result documents that is/are obtained based on a natural language prompt as described with respect to the method 400 of FIG. 4. In this example, the system can generate the corresponding vector (or embedding) representations of the corresponding portions of one or more of the plurality of search result documents, the corresponding BoW representations of the corresponding portions of one or more of the plurality of search result documents, etc. in response to the plurality of search result documents being obtained by the system. Further, the system can generate the corresponding vector (or embedding) representations of the responsive content, the corresponding BoW representations of the responsive content, etc. in response to the responsive content being generated. Again, this parallelization can have no or little impact on latency in causing the responsive content being provided for presentation to the user, and can be more robust when compared to only considering corresponding hashes of the corresponding segments and/or when compared to only considering the corresponding edit distance between the corresponding segments. Moreover, and in comparing these corresponding representations of the responsive content to the corresponding representations of the corresponding portions of one or more of the plurality of search result documents, the system can employ a cosine similarity algorithm or another distance-based matching algorithm to determine whether there is a match therebetween (e.g., if the similarity therebetween satisfies a threshold) and can adapt any subsequent processing based on that determination as described herein.

As yet another example, assume that the additional data is a corresponding segment of the GM training dataset. In this example, the system can generate the corresponding vector (or embedding) representations of the responsive content, the corresponding BoW representations of the responsive content, etc. in response to the responsive content being generated. In comparing these corresponding representations of the responsive content to the corresponding representations of the corresponding segment of the GM training dataset, the system can retrieve the previously generated and stored corresponding representations for the GM training dataset (e.g., as described with respect to the method 200 of FIG. 2). Further, the system can employ a cosine similarity algorithm or another distance-based matching algorithm to determine whether there is a match therebetween (e.g., if the similarity therebetween satisfies a threshold) and can adapt any subsequent processing based on that determination as described herein

In some implementations, the aforementioned corresponding representation approach can be utilized in addition to, or in lieu of, the edit distance approach described with respect to the method 600 of FIG. 6. For example, in some versions of those implementations, if the corresponding edit distance between the between the corresponding responsive content segment and the corresponding additional data fails to satisfy the threshold at the operations of block 662, then the system can compare the corresponding representations therebetween. As noted above, the corresponding representation approach can be more robust when compared to only considering the corresponding edit distance between the corresponding segments since it can take into account content that should be considered a match but is not an exact match (e.g., due to differences in formatting, differences in headings, and/or other non-substantive differences between the corresponding content). In some further versions of those implementations, the system may only compare the corresponding representations therebetween when the corresponding edit distance fails to satisfy the threshold at the operations of block 662, but is within a threshold range of the threshold. Thus, it should be understood that the system can use these corresponding representations in a selective and computationally efficient manner that balances the need for additional processing while reducing consumption of computational and/or network resources. However, in other implementations, the system can compare these corresponding representations, in addition to determining the corresponding edit distance, as means for validating the corresponding edit distance determination.

Turning now to FIG. 7, a flowchart illustrating an example method 700 of determining how to modify a corresponding segment of responsive content generated using a GM is depicted. For convenience, the operations of the method 700 are described with reference to a system that performs the operations. This system of the method 700 includes one or more processors, memory, and/or other component(s) of computing device(s) (e.g., client device 110 of FIG. 1, GM responsive content system 120 of FIG. 1, client device 810 of FIGS. 8A-8D, computing device 910 of FIG. 9, one or more servers, and/or other computing devices). Moreover, while operations of the method 700 are shown in a particular order, this is not meant to be limiting. One or more operations may be reordered, omitted, and/or added.

At block 752, the system determines whether to modify a corresponding segment of responsive content that matches a corresponding segment of additional data. The system can determine whether to modify a corresponding segment of responsive content that matches a corresponding segment of the additional data based on, for example, determinations made by the system at any one of the operations of blocks 356 and 358 of the method 300 of FIG. 3, the operations of blocks 364 and 366 of the method 300 of FIG. 3, the operations of blocks 460 and 462 of the method 400 of FIG. 4, the operations of blocks 556 and 558 of the method 500 of FIG. 5 If, at an iteration of block 752, the system determines not to modify the corresponding segment of the responsive content at an iteration of the method 700 of FIG. 7, then the system continues monitoring for whether to modify the corresponding segment of the responsive content and/or whether to modify additional segment(s) of the responsive content.

If, at an iteration of block 752, the system determines to modify the corresponding segment of the responsive content, then the system proceeds to block 754. At block 754, the system determines, based on a type of one or more sources associated with a corresponding segment of additional data that matches a corresponding segment of the responsive content, how to modify the corresponding segment of the responsive content. Notably, the type of one or more of the sources can be, for example, webpages (e.g., public domain webpages, licensed webpages, non-public domain webpages, and/or other webpages), electronic books (e.g., public domain electronic books and/or non-public domain electronic books), electronic documents (e.g., electronic word processing documents, electronic PDFs, etc.), electronic communications (e.g., electronic mail, SMS messages, social media posts or messages), software code (e.g., public domain software code, licensed software code, and/or non-public domain software code), electronic news articles, mathematical formulas, machine translation data, and/or any other data from any other source that is included in a plurality of search result documents (e.g., obtained using a RAG process and processed in generating the responsive content) and/or that was utilized to train and/or fine-tune the GM.

At block 756, the system determines one or more rules to apply to at least the corresponding segment of the responsive content and based on the type of one or more of the sources associated with the corresponding segment of additional data that matches the corresponding segment of the responsive content. Based on one or more of the sources associated with a corresponding segment of additional data that matches a corresponding segment of the responsive content, the system can cause the rules engine 161 dynamically apply one or more rules (e.g., stored in the rule(s) database 160A) to modify a corresponding segment of the responsive content. Additionally, or alternatively, the system can consider an extent to which a corresponding segment of additional data that matches a corresponding segment of the responsive content in determining one or more of the rules to be applied to a corresponding segment of the responsive content.

For example, if the system determines that the type of one or more of the sources associated with the corresponding segment of additional data that matches the corresponding segment of the responsive content is a first type, then the system proceeds to block 758. At block 758, the system modifies the corresponding segment to include a corresponding link to one or more of the sources associated with the corresponding segment of additional data that matches the corresponding segment of the responsive content. For example, in response to determining that one or more of the sources include a corresponding public domain webpage, a corresponding public domain electronic book, a corresponding electronic news article, or corresponding machine translation data, or other first types of sources, the rules engine 161 can determine to include a uniform resource locator (URL) to one or more of the sources. Accordingly, while the modification engine 162 may not modify alphanumeric characters of the corresponding segment of the responsive content, the modification engine 162 may still modify the corresponding segment of the responsive content to include the appropriate URL. This enables a user of the client device to quickly and efficiently access one or more of the sources via “one-click” of the URLs to one or more of the sources.

As another example, if the system determines that the type of one or more of the sources associated with the corresponding segment of additional data that matches the corresponding segment of the responsive content is a second type, then the system proceeds to block 760. At block 760, the system modifies the corresponding segment to include a corresponding first link to one or more of the sources associated with the corresponding segment of additional data that matches the corresponding segment of the responsive content and a corresponding second link to license(s) for one or more of the sources associated with the corresponding segment of additional data that matches the corresponding segment of the responsive content. For example, in response to determining that one or more of the sources include a corresponding licensed webpage, corresponding licensed software code, or other second types of sources, the rules engine 161 can determine to include a first URL to one or more of the sources and a second URL to license(s) associated with the additional content. Accordingly, while the modification engine 162 may not modify alphanumeric characters of the corresponding segment of the responsive content, the modification engine 162 may still modify the corresponding segment of the responsive content to include at least the first URL and the second URL. This enables a user of the client device to quickly and efficiently access the source(s) via “one-click” of the URL to one or more of the sources and to quickly and efficiently access license(s) associated with the one or more of the sources via “one-click” of the URL to the license(s) associated with the one or more of the sources.

As yet another example, if the system determines that the type of one or more of the sources associated with the corresponding segment of additional data that matches the corresponding segment of the responsive content is a third type, then the system proceeds to block 762. At block 762, the system modifies the corresponding segment of the responsive content to truncate the corresponding segment of the responsive content at N alphanumeric characters or within a threshold quantity of alphanumeric characters of the N alphanumeric characters, where N is a positive integer. For example, in response to determining that one or more of the sources include a corresponding non-public domain webpage, a corresponding non-public domain electronic book, or corresponding non-public domain software code, or other third types of sources, the rules engine 161 can determine to truncate the corresponding segment at 100 alphanumeric characters, 200 alphanumeric characters, 300 alphanumeric characters, or at any other N alphanumeric characters, thereby omitting any subsequent alphanumeric characters subsequent to the N alphanumeric characters. Accordingly, the modification engine 162 can remove all alphanumeric characters in the corresponding segment beyond the N alphanumeric character, remove all alphanumeric characters in the corresponding segment beyond the N alphanumeric characters and remove all alphanumeric characters prior to the N alphanumeric characters before the last sentence break or some other threshold quantity of alphanumeric characters before the N alphanumeric characters.

Additionally, or alternatively, if the system determines that the type of one or more of the sources associated with the corresponding segment of additional data that matches the corresponding segment of the responsive content is a third type, then the system proceeds to block 764. At block 764, the system determines whether to re-generate the corresponding segment of the responsive content (e.g., only the corresponding segment of the responsive content) or the responsive content (e.g., the responsive content in its entirety). Notably, whether the system proceeds to block 762 or 764 and from block 756 in response to determining determines that the type of one or more of the sources associated with the corresponding segment of additional data that matches the corresponding segment of the responsive content is a third type can be defined by a developer associated with the system. Further, whether the system proceeds to block 766 or 768 and from block 764 can also be defined by the developer associated with the system.

If, at an iteration of 764, the system determines to re-generate the corresponding segment of the responsive content, then the system proceeds to block 766. At block 766, the system re-generates the corresponding segment resulting in a corresponding alternative segment of the responsive content. In re-generating the corresponding segment, the system can cause the GM input engine 141 to determine GM input. The GM input can include, for example, the user input, other segments of the responsive content (e.g., other than the corresponding segment that is being modified), an indication to bias away from the corresponding segment in re-generating the corresponding segment, and/or other information. Further, the system can cause the GM processing engine 142 to process, using the GM, the GM input to generate GM output. Moreover, the system can cause the GM output engine 143 to determine, based on the GM output, the corresponding alternative segment of the responsive content.

If, at an iteration of 764, the system determines to re-generate the responsive content, then the system proceeds to block 768. At block 768, the system re-generates the responsive content resulting in alternative responsive content. In re-generating the corresponding segment, the system can cause the GM input engine 141 to determine GM input. The GM input can include, for example, the user input, the responsive content, an indication to bias away from the corresponding segment in re-generating the responsive content, and/or other information. Further, the system can cause the GM processing engine 142 to process, using the GM, the GM input to generate GM output. Moreover, the system can cause the GM output engine 143 to determine, based on the GM output, the alternative segment content.

Notably, and prior to performing the operations of block 766 or block 768, the system can modify tunable parameters of the GM and/or various engines described herein. For example, the system can modify a temperature parameter of the GM prior to re-generating the corresponding segment or re-generating the responsive content. As another example, the system can modify a decoding technique utilized by the GM output engine 143.

Although certain rules for certain sources are described above, it should be understood that is for the sake of example to illustrate various techniques contemplated herein and is not meant to be limiting. For example, if a corresponding segment of the responsive content includes more than N alphanumeric characters that match a corresponding segment of the additional data, but less than M alphanumeric characters that match a corresponding segment of the additional data (e.g., where N and M are positive integers, and where M is greater than N), then the system can determine to modify the corresponding segment of the responsive content as described with respect to the operations of block 758 or block 760. However, and continuing with the above example, if the corresponding segment of the responsive content responsive content includes more than M alphanumeric characters that match a corresponding segment of the additional data, then the system can truncate the corresponding segment at the M alphanumeric characters (or within a threshold of the M alphanumeric characters). In this example, the system can determine to modify the corresponding segment of the responsive content as described with respect to the operations of block 758 or block 760, and the system can optionally insert an ellipsis into the corresponding segment of the responsive content. In causing the modified responsive content to be rendered, the system can output a first version of the modified responsive content that omits the ellipsis and a second version of the modified responsive that includes the ellipsis, thereby enabling a user associated with the client device to choose the first version of the modified responsive content or the second version of the modified responsive content. This can be particularly advantageous in certain scenarios, such as when the modified responsive content is generative software code since the ellipsis may not be desirable in the generative software code, but may be desirable in generative text. Other rules are contemplated herein, and the aforementioned rules are not meant to be limiting.

Turning now to FIGS. 8A-8D, various non-limiting examples of a client device rendering responsive content generated using a GM are depicted. A client device 110 (e.g., an instance of the client device 110 of FIG. 1) may include various user interface components including, for example, microphone(s) to generate audio data based on spoken utterances and/or other audible input, speaker(s) to audibly render synthesized speech and/or other audible output, and/or a display 180 to visually render visual output. Further, the display 180 of the client device 110 can include various system interface elements 181, 182, and 183 (e.g., hardware and/or software interface elements) that may be interacted with by a user of the client device 110 to cause the client device 110 to perform one or more actions. The display 180 of the client device 110 enables the user to interact with content rendered on the display 180 by touch input (e.g., by directing user input to the display 180 or portions thereof (e.g., to a text entry box 184, to a keyboard (not depicted), or to other portions of the display 180)) and/or by spoken input (e.g., by selecting microphone interface element 185—or just by speaking without necessarily selecting the microphone interface element 185 (i.e., an automated assistant may monitor for one or more terms or phrases, gesture(s) gaze(s), mouth movement(s), lip movement(s), and/or other conditions to activate spoken input) at the client device 110). Although the client device 110 depicted in FIGS. 8A-8D is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other device capable of executing an automated assistant to engage in a human-to-computer dialog session with the user of the client device 110.

Referring specifically to FIG. 8A, assume that a user of the client device 110 is interacting with the GM responsive content system 120 such as via an automated assistant that has access to the GM responsive content system 120, via a generative responsive content software application that has access to the GM responsive content system 120, via a generative content webpage that has access to the GM responsive content system 120, etc. Further assume that, while the user is interacting with the GM responsive content system 120, the user of the client device provides user input that includes a natural language prompt 852A of “can you help me troubleshoot my home robot?” and that includes user provided content associated with the user's home robot as indicated at 854A (e.g., an electronic user manual associated with the user's home robot, which may tens of pages, hundreds of pages, or thousands of pages). Further assume that the GM responsive content system 120 generates and renders responsive content 856A that includes various tips associated with troubleshooting the user's home robot and based on processing the natural language prompt 852A and the electronic user manual associated with the user's home robot. Although the example of FIG. 8A is described with respect to the user explicitly uploading the electronic user manual associated with the user's home robot, it should be understood that is for the sake of example and is not meant to be limiting. For example, it should be understood that the natural language prompt 852A can be interpreted as an implicit process to obtain the electronic user manual associated with the user's home robot (e.g., via local storage or cloud storage of the user).

In the example of FIG. 8A, corresponding segments of the responsive content 856A may match corresponding segments of the electronic user manual associated with the user's home robot. For instance, the “[first tip]”, the “[second tip]”, the “[third tip]”, . . . , and the “[Nth tip]” may match troubleshooting tips that are included in different portions of the electronic user manual associated with the user's home robot (where N is a positive integer greater than three). Nonetheless, and assuming the “[first tip]”, the “[second tip]”, the “[third tip]”, . . . , and the “[Nth tip]” match the troubleshooting tips that are included in different portions of the electronic user manual associated with the user's home robot, there is no need to perform additional processing to modify these segments of the responsive content 856A, to determine whether these segments of the responsive content 856A match search result documents (if any), or to determine whether these segments of the responsive content 856A match GM training data of a GM training dataset that was utilized to train and/or fine-tune the GM (e.g., even if the GM was trained and/or fine-tuned based on the electronic user manual associated with the user's home robot). Accordingly, this additional processing is obviated since these segments of the responsive content 856A can be grounded in the user provided content (e.g., the electronic user manual associated with the user's home robot).

Referring specifically to FIG. 8B, again assume that a user of the client device 110 is interacting with the GM responsive content system 120. However, in contrast with the example of FIG. 8A, assume that, while the user is interacting with the GM responsive content system 120, the user of the client device provides user input 852B (or a natural language prompt) of “can you help me troubleshoot my home robot?”, but does not include any user provided content as in the example of FIG. 8A. Further assume that the GM responsive content system 120 generates and renders responsive content 854B that includes the same tips associated with troubleshooting the user's home robot as in the responsive content 856A from the example of FIG. 8A. However, in the example of FIG. 8B, assume that the responsive content 854B is generated based on processing the user input 852B and search result documents that include an electronic user manual associated with the user's home robot obtained via a RAG process.

In the example of FIG. 8B, corresponding segments of the responsive content 854B may match corresponding segments of the search result documents (e.g., the electronic user manual associated with the user's home robot). For instance, the “[first tip]”, the “[second tip]”, the “[third tip]”, . . . , and the “[Nth tip]” may match troubleshooting tips that are included in different portions of the electronic user manual associated with the user's home robot (where N is a positive integer greater than three) in search result documents obtained via the RAG process. In this example, and assuming the “[first tip]”, the “[second tip]”, the “[third tip]”, . . . , and the “[Nth tip]” match the troubleshooting tips that are included in different portions of the electronic user manual associated with the user's home robot, the system can modify each of these segments to include a reference to a source of these segments (e.g., where S1 is a corresponding link to the electronic user manual associated with the user's home robot obtained via the RAG process). Nonetheless, there is no need to determine whether these segments of the responsive content 854B match GM training data of a GM training dataset that was utilized to train and/or fine-tune the GM (e.g., even if the GM was trained and/or fine-tuned based on the electronic user manual associated with the user's home robot). Accordingly, this additional processing is obviated since these segments of the responsive content 854B can be grounded in the search result documents (e.g., the electronic user manual associated with the user's home robot).

Referring specifically to FIG. 8C, again assume that a user of the client device 110 is interacting with the GM responsive content system 120. However, similar to the example of FIG. 8B, assume that, while the user is interacting with the GM responsive content system 120, the user of the client device provides user input 852C (or a natural language prompt) of “can you help me troubleshoot my home robot?”, but does not include any user provided content as in the example of FIG. 8A and no RAG process is performed in the example of FIG. 8B. Further assume that the GM responsive content system 120 generates and renders responsive content 854C that includes the same tips associated with troubleshooting the user's home robot as in the responsive content 856A from the example of FIG. 8A and in the responsive content 854B from the example of FIG. 8B and based on processing the user input (e.g., and without processing any user provided content or search result documents).

In the example of FIG. 8C, corresponding segments of the responsive content 854C may match corresponding segments of GM training data that was utilized to initially train and/or fine-tune the GM (e.g., the electronic user manual associated with the user's home robot). For instance, the “[first tip]”, the “[second tip]”, the “[third tip]”, . . . , and the “[Nth tip]” may match troubleshooting tips that are included in different portions of the electronic user manual associated with the user's home robot (where N is a positive integer greater than three) in the GM training dataset. In this example, and assuming the “[first tip]”, the “[second tip]”, the “[third tip]”, . . . , and the “[Nth tip]” match the troubleshooting tips that are included in different portions of the electronic user manual associated with the user's home robot, the system can modify each of these segments to include a reference to a source of these segments (e.g., where S1 is a corresponding link to the electronic user manual associated with the user's home robot obtained utilized in training and/or fine-tuning the GM). In this example, there is no need to determine whether these segments of the responsive content 854C match any user provided content or search result documents. However, there is still a need to determine whether these segments match segments of a GM training dataset that was utilized to train and/or fine-tune the GM. Thus, throughout the examples of FIGS. 8A, 8B, and 8C, a search space for matching segments can initially be constrained, but can be progressively increased, and depending on source(s) of matching segments of additional data, subsequent processing of the responsive content can be adapted.

Referring specifically to FIG. 8D, again assume that a user of the client device 110 is interacting with the GM responsive content system 120. However, in contrast with the examples of FIGS. 8A, 8B, and 8C, assume that, while the user is interacting with the GM responsive content system 120, the user of the client device provides user input 852DC (or a natural language prompt) of “can you write a story about my home robot saving the world?”, but does not include any user provided content as in the example of FIG. 8A and no RAG process is performed in the example of FIG. 8B. Further assume that the GM responsive content system 120 generates and renders responsive content 854D and based on processing the user input (e.g., and without processing any user provided content or search result documents). In the example of FIG. 8D, further assume that no corresponding segments of the responsive content 854D match corresponding segments of GM training data that was utilized to initially train and/or fine-tune the GM. Accordingly, the responsive content 854D is rendered as is and without any modification.

Although certain examples are depicted in FIGS. 8A-8D, it should be understood that those examples are provided to illustrate some techniques contemplated and are not meant to be limiting. Further, although certain rules are described as being applied to modify the responsive content in the examples of FIGS. 8B and 8C, it should be understood that is not meant to be limiting. Rather, it should be understood that the rules applied to modify the responsive content are based on source(s) associated with additional data that match segments of the responsive content (e.g., as described with respect to FIG. 7).

Turning now to FIG. 9, a block diagram of an example computing device 910 that may optionally be utilized to perform one or more aspects of techniques described herein is depicted. In some implementations, one or more of a client device, cloud-based automated assistant component(s), and/or other component(s) may comprise one or more components of the example computing device 910.

Computing device 910 typically includes at least one processor 914 which communicates with a number of peripheral devices via bus subsystem 912. These peripheral devices may include a storage subsystem 924, including, for example, a memory subsystem 925 and a file storage subsystem 926, user interface output devices 920, user interface input devices 922, and a network interface subsystem 916. The input and output devices allow user interaction with computing device 910. Network interface subsystem 916 provides an interface to outside networks and is coupled to corresponding interface devices in other computing devices.

User interface input devices 922 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 910 or onto a communication network.

User interface output devices 920 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 910 to the user or to another machine or computing device.

Storage subsystem 924 stores programming and data constructs that provide the functionality of some or all of the modules described herein. For example, the storage subsystem 924 may include the logic to perform selected aspects of the methods disclosed herein, as well as to implement various components depicted in FIG. 1.

These software modules are generally executed by processor 914 alone or in combination with other processors. Memory 925 used in the storage subsystem 924 can include a number of memories including a main random access memory (RAM) 930 for storage of instructions and data during program execution and a read only memory (ROM) 932 in which fixed instructions are stored. A file storage subsystem 926 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 926 in the storage subsystem 924, or in other machines accessible by the processor(s) 914.

Bus subsystem 912 provides a mechanism for letting the various components and subsystems of computing device 910 communicate with each other as intended. Although bus subsystem 912 is shown schematically as a single bus, alternative implementations of the bus subsystem 912 may use multiple busses.

Computing device 910 can be of varying types including a workstation, server, computing cluster, blade server, server farm, or any other data processing system or computing device. Due to the ever-changing nature of computers and networks, the description of computing device 910 depicted in FIG. 9 is intended only as a specific example for purposes of illustrating some implementations. Many other configurations of computing device 910 are possible having more or fewer components than the computing device depicted in FIG. 9.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a system is provided that includes at least one processor; and memory storing instructions that, when executed by the at least one processor, cause the at least one processor to be operable to: receive user input that is associated with a client device of a user, the user input including user provided content and a natural language prompt; generate, based on processing at least the user provided content and the natural language prompt and using a generative model (GM), responsive content that is responsive to the natural language prompt; determine whether a corresponding segment of the responsive content matches a corresponding segment of the user provided content; and in response to determining that a corresponding segment of the responsive content matches a corresponding segment of the user provided content: refrain from modifying the corresponding segment of the responsive content; and cause the responsive content to be rendered at the client device of the user. By refraining from modifying the corresponding segment of the responsive content in situations where a corresponding segment of the responsive content matches a corresponding segment of the user provided content, computational and/or network resources can be conserved by obviating the need for additional processing to modify the corresponding responsive content. Further, latency can be reduced in causing the responsive content to be rendered at the client device of the user.

These and other implementations of technology disclosed herein can optionally include one or more of the following features.

In some implementations, the instructions to determine whether a corresponding segment of the responsive content matches a corresponding segment of the user provided content may include instructions to: normalize, using one or more normalization operations, the user provided content to generate normalized user provided content; segment the normalized user provided content into a plurality of normalized user provided content segments; normalize, using the one or more normalization operations, the responsive content to generate normalized responsive content; segment the normalized responsive content into a plurality of normalized responsive content segments; and determine, based on a comparison of the plurality of normalized user provided content segments and the plurality of normalized responsive content segments, whether a corresponding segment of the responsive content matches a corresponding segment of the user provided content.

In some versions of those implementations, each of the plurality of normalized user provided content segments may include a fixed number of alphanumeric characters starting at a corresponding word boundary of the user provided content, and one or more of the plurality of normalized user provided content segments may include overlapping alphanumeric characters.

In additional or alternative versions of those implementations, the user provided content may be normalized and segmented while the responsive content that is responsive to the natural language prompt is being generated. By normalizing and segmenting the user provided content while the responsive content is being generated, latency in causing the responsive content to be rendered at the client device of the user via parallelized processing.

In additional or alternative versions of those implementations, each of the plurality of normalized responsive content segments may include a fixed number of alphanumeric characters starting at a corresponding word boundary of the responsive content, and one or more of the plurality of normalized responsive content segments may include overlapping alphanumeric characters.

In additional or alternative versions of those implementations, the plurality of normalized responsive content segments may be generated subsequent to the responsive content that is responsive to the natural language prompt is being generated.

In some implementations, the at least one processor may be further operable to, in response to determining that no corresponding segment of the responsive content matches a corresponding segment of the user provided content: determine whether a corresponding segment of the responsive content matches a corresponding segment of a GM training dataset that was utilized to train the GM; and in response to determining that no corresponding segment of the responsive matches a corresponding segment of a GM training dataset that was utilized to train the GM: refrain from modifying the corresponding segment of the responsive content; and cause the responsive content to be rendered at the client device of the user.

In some implementations, the at least one processor may be further operable to, in response to determining that no corresponding segment of the responsive content matches a corresponding segment of the user provided content: determine whether a corresponding segment of the responsive content matches a corresponding segment of a GM training dataset that was utilized to train the GM; and in response to determining that a corresponding segment of the responsive content matches a corresponding segment of a GM training dataset that was utilized to train the GM: modify at least the corresponding segment of the responsive content to generate modified responsive content; and cause the modified responsive content, and in lieu of the responsive content, to be rendered at the client device of the user.

In some versions of those implementations, the instructions to determine whether a corresponding segment of the responsive content matches a corresponding segment of the GM training dataset that was utilized to train the GM may include instructions to: normalize, using one or more normalization operations, the responsive content to generate normalized responsive content; segment the normalized responsive content into a plurality of normalized responsive content segments; and determine, based on a comparison of the plurality of normalized responsive content segments and a plurality of normalized GM training dataset segments for the GM training dataset, whether a corresponding segment of the responsive content matches a corresponding segment of the GM training dataset that was utilized to train the GM.

In some further versions of those implementations, the at least one processor may be further operable to, prior to receiving the user input that is associated with the client device of the user: normalize, using the one or more normalization operations, the GM training dataset to generate a normalized GM training dataset; and segment the normalized GM training dataset into the plurality of normalized GM training dataset segments. Each of the plurality of normalized GM training dataset segments for the GM training dataset may include a fixed number of alphanumeric characters starting at a corresponding word boundary of a portion of the GM training dataset, and one or more of the plurality of normalized GM training dataset segments may include overlapping alphanumeric characters.

In additional or alternative further versions of those implementations, each of the plurality of normalized responsive content segments may include a fixed number of alphanumeric characters starting at a corresponding word boundary of the responsive content, and one or more of the plurality of normalized responsive content segments may include overlapping alphanumeric characters.

In additional or alternative further versions of those implementations, the plurality of normalized responsive content segments may be generated subsequent to the responsive content that is responsive to the natural language prompt being generated.

In additional or alternative versions of those implementations, modifying at least the corresponding segment of the responsive content to generate the modified responsive content may be based on a corresponding source of the corresponding segment of the GM training dataset that matches the corresponding segment of the responsive content.

In further additional or alternative versions of those implementations, the at least one processor may be further operable to: modify, based on the corresponding source of the corresponding segment of the GM training dataset that matches the corresponding segment of the responsive content being a first type of source, the responsive content to include a corresponding link to the corresponding source.

In further additional or alternative versions of those implementations, the at least one processor may be further operable to: modify, based on the corresponding source of the corresponding segment of the GM training dataset that matches the corresponding segment of the responsive content being a second type of source, the responsive content to include a first corresponding link to the corresponding source and a second corresponding link to a corresponding license associated with the corresponding source.

In further additional or alternative versions of those implementations, the at least one processor may be further operable to: modify, based on the corresponding source of the corresponding segment of the GM training dataset that matches the corresponding segment of the responsive content being a third type of source, the responsive content to truncate the corresponding segment of the responsive content at N alphanumeric characters or to truncate the corresponding segment of the responsive content within a threshold quantity of alphanumeric characters of the N alphanumeric characters, wherein N is a positive integer.

In further additional or alternative versions of those implementations, the at least one processor may be further operable to: modify, based on the corresponding source of the corresponding segment of the GM training dataset that matches the corresponding segment of the responsive content being a third type of source, the responsive content to omit the corresponding segment of the responsive content.

In yet further additional or alternative versions of those implementations, the at least one processor may be further operable to: in response to modifying the responsive content to omit the corresponding segment of the responsive content, determine to re-generate the corresponding segment of the responsive content; and generate, based on processing at least the user provided content, the natural language prompt, and an indication of the corresponding segment of the responsive content and using the GM, an alternative corresponding segment for the responsive content that is responsive to the natural language prompt and that differs from the corresponding segment of the responsive content.

In even yet further additional or alternative versions of those implementations, the instructions to generate the alternative corresponding segment for the responsive content that is responsive to the natural language prompt and that differs from the corresponding segment of the responsive content may further include instructions to: bias generating of the alternative corresponding segment away from one or more terms of the corresponding segment of the responsive content.

In further additional or alternative versions of those implementations, the at least one processor may be further operable to: in response to modifying the responsive content to omit the corresponding segment of the responsive content, determine to re-generate the responsive content; and generate, based on processing at least the user provided content, the natural language prompt, and the responsive content and using the GM, alternative responsive content that is responsive to the natural language prompt and that differs from the responsive content.

In yet further additional or alternative versions of those implementations, the at least one processor may be further operable to, prior to generating the alternative responsive content that is responsive to the natural language prompt and that differs from the responsive content: modify one or more tunable parameters of the GM.

In some implementations, the instructions to cause the responsive content to be rendered at the client device of the user may include instructions to: transmit data indicative of the responsive content to the client device. Transmitting the data indicative of the responsive content to the client device may cause the client device to visually render the responsive content via a display of the client device and/or audibly render the responsive content via one or more speakers of the client device.

In some implementations, the instructions to cause the responsive content to be rendered at the client device of the user may include instructions to: cause the responsive content to be visually rendered via a display of the client device and/or audibly rendered via one or more speakers of the client device.

In some implementations, in response to determining that a corresponding segment of the responsive content matches a corresponding segment of the user provided content, the least at least one processor may be further operable to: identify a portion of the user provided content including the corresponding segment of the user provided content that matches the corresponding segment of the responsive content; and cause an indication of the portion of the user provided content to be rendered at the client device of the user.

In some versions of those implementations, the indication of the portion of the user provided content may be selectable and, when selected, causes the client device of the user to navigate to the portion of the user provided content. By enabling the user to provide a single input (e.g., via a selection of the indication of the indication of the portion of the user provided content), the user need not manually search the user provided content, thereby reducing a quantity of user inputs received at the client device and conversing computational and/or network resources.

In additional or alternative versions of those implementations, the at least one processor may be further operable to: receive additional user input that is associated with the client device of the user, the additional user input including a selection of the indication of the portion of the user provided content; and one of: cause the client device to launch a software application that navigates to the portion of the user provided content; or cause the client device to open a document that navigates to the portion of the user provided content. By enabling the user to provide a single input (e.g., via a selection of the indication of the indication of the portion of the user provided content), the user need not manually search the user provided content, thereby reducing a quantity of user inputs received at the client device and conversing computational and/or network resources.

In some implementations, the instructions to determine whether a corresponding segment of the response content matches a corresponding segment of the user provided content may include instructions to: generate, using a hash function, a plurality of corresponding hashes for the user provided content; generate, using the hash function, a plurality of corresponding hashes for the responsive content; compare the plurality of corresponding hashes for the user provided content to the plurality of corresponding hashes for the responsive content; and determine, based on a comparison of the plurality of corresponding hashes for the user provided content to the plurality of corresponding hashes for the responsive content, whether a corresponding segment of the responsive content matches a corresponding segment of the user provided content.

In some versions of those implementations, each of the plurality of corresponding hashes for the user provided content may include a fixed number of alphanumeric characters starting at a corresponding word boundary of the user provided content, and one or more of the plurality of corresponding hashes for the user provided content may include overlapping alphanumeric characters.

In additional or alternative versions of those implementations, the plurality of corresponding hashes for the user provided content may be generated, in parallel, while the responsive content that is responsive to the natural language prompt is being generated.

In additional or alternative versions of those implementations, each of the plurality of corresponding hashes for the responsive content may include a fixed number of alphanumeric characters starting at a corresponding word boundary of the responsive content, and one or more of the plurality of corresponding hashes for the responsive content may include overlapping alphanumeric characters.

In additional or alternative versions of those implementations, the plurality of corresponding hashes for the responsive content may be generated subsequent to the responsive content that is responsive to the natural language prompt is being generated.

In further versions of those implementations, the instructions to determine whether a corresponding segment of the responsive content matches a corresponding segment of the GM training dataset that was utilized to train the GM may include instructions to: generate, using a hash function, a plurality of corresponding hashes for the responsive content; compare the plurality of corresponding hashes for the responsive content to a plurality of corresponding hashes for the GM training dataset that was utilized to train the GM; and determine, based on a comparison of the plurality of corresponding hashes for the responsive content to the plurality of corresponding hashes for the GM training dataset, whether a corresponding segment of the responsive content matches a corresponding segment of the GM training dataset that was utilized to train the GM.

In yet further versions of those implementations, the at least one processor may be further operable to, prior to receiving the user input that is associated with the client device of the user: generate, using the hash function, the plurality of corresponding hashes for the GM training dataset. Each of the plurality of corresponding hashes for the GM training dataset may include a fixed number of alphanumeric characters starting at a corresponding word boundary of a portion of the GM training dataset, and one or more of the plurality of corresponding hashes for the GM training dataset may include overlapping alphanumeric characters.

In additional or alternative yet further versions of those implementations, each of the plurality of corresponding hashes for the responsive content may include a fixed number of alphanumeric characters starting at a corresponding word boundary of the responsive content, and one or more of the plurality of corresponding hashes for the responsive content may include overlapping alphanumeric characters.

In additional or alternative yet further versions of those implementations, the plurality of corresponding hashes for the responsive content may be generated subsequent to the responsive content that is responsive to the natural language prompt being generated.

In additional or alternative yet further versions of those implementations, the instructions to determine whether a corresponding segment of the responsive content matches a corresponding segment of the user provided content may be executed in response to determining that a corresponding segment of the responsive content matches a corresponding segment of the GM training dataset based on a comparison of the plurality of corresponding hashes for the responsive content to the plurality of corresponding hashes for the GM training dataset.

In even yet further versions of those implementations, the instructions to refrain from modifying the corresponding segment of the responsive content may be executed in response to determining that there is an exact match between a corresponding segment of the responsive content and a corresponding segment of the user provided content.

In additional or alternative even yet further versions of those implementations, the instructions to refrain from modifying the corresponding segment of the responsive content may be executed in response to determining that there is a fuzzy match between a corresponding segment of the responsive content and a corresponding segment of the user provided content.

In some implementations, a system is provided that includes at least one processor; and memory storing instructions that, when executed by the at least one processor, cause the at least one processor to be operable to: receive user input that is associated with a client device of a user; determine, based on the user input, one or more search queries; obtain, based on the one or more search queries, a plurality of search result documents; generate, based on processing at least the user input and a corresponding portion of one or more of the plurality of search result documents and using a generative model (GM), responsive content that is responsive to the user input; determine whether a corresponding segment of the responsive content matches a corresponding segment of one or more of the plurality of search result documents; in response to determining that a corresponding segment of the responsive content matches a corresponding segment of one or more of the plurality of search result documents: determine, based on one or more sources associated with the corresponding segment of one or more of the plurality of search result documents, whether to modify the corresponding segment of the responsive content; and in response to determining to modify the corresponding segment of the responsive content based on the one or more sources associated with the corresponding segment of one or more of the plurality of search result documents: modify at least the corresponding segment of the responsive content to generate modified responsive content; and cause the modified responsive content, and in lieu of the responsive content, to be rendered at the client device of the user. By initially restricting a search space to the search result documents for determining whether to modify the corresponding segment of the responsive content, a more efficient search can be performed across this restricted search space, thereby increasing efficiency in the processing and reducing latency in causing the responsive content to be rendered at the client device.

These and other implementations of technology disclosed herein can optionally include one or more of the following features.

In some implementations, the instructions to determine whether a corresponding segment of the responsive content matches a corresponding segment of one or more of the plurality of search result documents may include instructions to: normalize, using one or more normalization operations, each of the plurality of search result documents to generate a plurality of normalized search result documents; segment the plurality of normalized search result documents into a plurality of normalized search result document segments; normalize, using the one or more normalization operations, the responsive content to generate normalized responsive content; segment the normalized responsive content into a plurality of normalized responsive content segments; and determine, based on a comparison of the plurality of normalized search result document segments and the plurality of normalized responsive content segments, whether a corresponding segment of the responsive content matches a corresponding segment of one or more of the plurality of search result documents.

In some versions of those implementations, each of the plurality of normalized search result document segments may include a fixed number of alphanumeric characters starting at a corresponding word boundary of a given one of the plurality of search result documents, and one or more of the plurality of normalized search result document segments may include overlapping alphanumeric characters.

In additional or alternative versions of those implementations, the plurality of search result documents may be normalized and segmented while the responsive content that is responsive to the user input is being generated. By normalizing and segmenting the search result documents while the responsive content is being generated, latency in causing the responsive content to be rendered at the client device of the user via parallelized processing.

In additional or alternative versions of those implementations, each of the plurality of normalized responsive content segments may include a fixed number of alphanumeric characters starting at a corresponding word boundary of the responsive content, and one or more of the plurality of normalized responsive content segments may include overlapping alphanumeric characters.

In additional or alternative versions of those implementations, the plurality of normalized responsive content segments may be generated subsequent to the responsive content that is responsive to the user input being generated.

In some implementations, the at least one processor may be further operable to, in response to determining that no corresponding segment of the responsive content matches a corresponding segment of one or more of the plurality of search result documents: determine whether a corresponding segment of the responsive content matches a corresponding segment of a GM training dataset that was utilized to train the GM; and in response to determining that no corresponding segment of the responsive matches a corresponding segment of a GM training dataset that was utilized to train the GM: refrain from modifying the corresponding segment of the responsive content; and cause the responsive content to be rendered at the client device of the user.

In some implementations, the at least one processor may be further operable to, in response to determining that no corresponding segment of the responsive content matches a corresponding segment of one or more of the plurality of search result documents: determine whether a corresponding segment of the responsive content matches a corresponding segment of a GM training dataset that was utilized to train the GM; and in response to determining that a corresponding segment of the responsive content matches a corresponding segment of a GM training dataset that was utilized to train the GM: modify at least the corresponding segment of the responsive content to generate modified responsive content; and cause the modified responsive content, and in lieu of the responsive content, to be rendered at the client device of the user.

In some versions of those implementations, the instructions to determine whether a corresponding segment of the responsive content matches a corresponding segment of the GM training dataset that was utilized to train the GM may include instructions to: normalize, using one or more normalization operations, the responsive content to generate normalized responsive content; segment the normalized responsive content into a plurality of normalized responsive content segments; and determine, based on a comparison of the plurality of normalized responsive content segments and a plurality of normalized GM training dataset segments for the GM training dataset, whether a corresponding segment of the responsive content matches a corresponding segment of the GM training dataset that was utilized to train the GM.

In some further versions of those implementations, the at least one processor may be further operable to, prior to receiving the user input that is associated with the client device of the user: normalize, using the one or more normalization operations, the GM training dataset to generate a normalized GM training dataset; and segment the normalized GM training dataset into the plurality of normalized GM training dataset segments. Each of the plurality of normalized GM training dataset segments for the GM training dataset may include a fixed number of alphanumeric characters starting at a corresponding word boundary of a portion of the GM training dataset, and one or more of the plurality of normalized GM training dataset segments may include overlapping alphanumeric characters.

In additional or alternative further versions of those implementations, each of the plurality of normalized responsive content segments include a fixed number of alphanumeric characters starting at a corresponding word boundary of the responsive content, and wherein one or more of the plurality of normalized responsive content segments include overlapping alphanumeric characters.

In additional or alternative further versions of those implementations, the plurality of normalized responsive content segments may be generated subsequent to the responsive content that is responsive to the natural language prompt being generated.

In some implementations, the at least one processor may be further operable to, in response to determining to not modify the corresponding segment of the responsive content based on the one or more sources associated with the corresponding segment of one or more of the plurality of search result documents: refrain from modifying the corresponding segment of the responsive content; and cause the responsive content to be rendered at the client device of the user.

In some implementations, modifying at least the corresponding segment of the responsive content to generate the modified responsive content may be based on a type of one or more of the sources associated with the corresponding segment of one or more of the plurality of search result documents that matches the corresponding segment of the responsive content.

In some implementations, the at least one processor may be further operable to: modify, based on a type of one or more of the sources associated with the corresponding segment of one or more of the plurality of search result documents that matches the corresponding segment of the responsive content being a first type of source, the responsive content to include a corresponding link to one or more of the sources associated with the corresponding segment of one or more of the plurality of search result documents.

In some implementations, the at least one processor may be further operable to: modify, based on a type of one or more of the sources associated with the corresponding segment of one or more of the plurality of search result documents that matches the corresponding segment of the responsive content being a second type of source, the responsive content to include a first corresponding link to one or more of the sources associated with the corresponding segment of one or more of the plurality of search result documents and a second corresponding link to a corresponding license associated one or more of the sources associated with the corresponding segment of one or more of the plurality of search result documents.

In some implementations, the at least one processor may be further operable to: modify, based on a type of one or more of the sources associated with the corresponding segment of one or more of the plurality of search result documents that matches the corresponding segment of the responsive content being a third type of source, the responsive content to truncate the corresponding segment of the responsive content at N alphanumeric characters or to truncate the corresponding segment of the responsive content within a threshold quantity of alphanumeric characters of the N alphanumeric characters, where N is a positive integer.

In some implementations, the at least one processor may be further operable to: modify, based on a type of one or more of the sources associated with the corresponding segment of one or more of the plurality of search result documents that matches the corresponding segment of the responsive content being a third type of source, the responsive content to omit the corresponding segment of the responsive content.

In some versions of those implementation, the at least one processor may be further operable to: in response to modifying the responsive content to omit the corresponding segment of the responsive content, determine to re-generate the corresponding segment of the responsive content; and generate, based on processing at least the user input, the corresponding portion of one or more of the plurality of search result documents, and an indication of the corresponding segment of the responsive content and using the GM, an alternative corresponding segment for the responsive content that is responsive to the natural language prompt and that differs from the corresponding segment of the responsive content.

In some further versions of those implementations, the instructions to generate the alternative corresponding segment for the responsive content that is responsive to the natural language prompt and that differs from the corresponding segment of the responsive content may further include instructions to: bias generating of the alternative corresponding segment away from one or more terms of the corresponding segment of the responsive content.

In additional or alternative versions of those implementations, the at least one processor may be further operable to, in response to modifying the responsive content to omit the corresponding segment of the responsive content, determine to re-generate the responsive content; and generate, based on processing at least the user input, the corresponding portion of one or more of the plurality of search result documents, and an indication of the corresponding segment of the responsive content and using the GM, alternative responsive content that is responsive to the natural language prompt and that differs from the responsive content.

In some further versions of those implementations, the at least one processor may be further operable to, prior to generating the alternative responsive content that is responsive to the natural language prompt and that differs from the responsive content: modify one or more tunable parameters of the GM.

In some implementations, the instructions to cause the modified responsive content to be rendered at the client device of the user may include instructions to: transmit data indicative of the modified responsive content to the client device, wherein transmitting the data indicative of the modified responsive content to the client device causes the client device to visually render the modified responsive content via a display of the client device and/or audibly render the modified responsive content via one or more speakers of the client device.

In some implementations, the instructions to cause the modified responsive content to be rendered at the client device of the user may include instructions to: cause the modified responsive content to be visually rendered via a display of the client device and/or audibly rendered via one or more speakers of the client device.

In some implementations, the instructions to determine the one or more search queries may include instructions to: generate, based on processing at least the user input and an instruction to generate the one or more search queries based on the user input and using the GM or the additional GM, the one or more search queries.

In some implementations, the instructions to determine the one or more search queries may include instructions to: obtain, based on the user input, the one or more search queries, the one or more search queries being stored in association with one or more terms of the user input.

In some implementations, the instructions to obtain the plurality of search result documents based on the one or more search queries may include instructions to: submit, to a search system, each of the one or more search queries to obtain a superset of search result documents; and select, from the superset of the search result documents, the plurality of search result documents.

In some implementations, the corresponding portion of one or more of the plurality of search result documents that are processed to generate the responsive content may be a corresponding snippet for each of the plurality of search result documents.

In some implementations, the instructions to determine whether a corresponding segment of the responsive content matches a corresponding segment of one or more of the plurality of search result documents may include instructions to: generate, using a hash function, a plurality of corresponding hashes for the one or more of the plurality of search result documents; generate, using the hash function, a plurality of corresponding hashes for the responsive content; compare the plurality of corresponding hashes for the one or more of the plurality of search result documents to the plurality of corresponding hashes for the responsive content; and determine, based on a comparison of the plurality of corresponding hashes for the one or more of the plurality of search result documents to the plurality of corresponding hashes for the responsive content, whether a corresponding segment of the responsive content matches a corresponding segment of one or more of the plurality of search result documents.

In some versions of those implementations, each of the plurality of corresponding hashes for the one or more of the plurality of search result documents may include a fixed number of alphanumeric characters starting at a corresponding word boundary of the one or more of the plurality of search result documents, and one or more of the plurality of corresponding hashes for the one or more of the plurality of search result documents may include overlapping alphanumeric characters.

In additional or alternative versions of those implementations, the plurality of corresponding hashes for the one or more of the plurality of search result documents may be generated, in parallel, while the responsive content that is responsive to the user input is being generated.

In additional or alternative versions of those implementations, each of the plurality of corresponding hashes for the responsive content may include a fixed number of alphanumeric characters starting at a corresponding word boundary of the responsive content, and one or more of the plurality of corresponding hashes for the responsive content may include overlapping alphanumeric characters.

In additional or alternative versions of those implementations, the plurality of corresponding hashes for the responsive content may be generated subsequent to the responsive content that is responsive to the user input being generated.

In some additional or alternative further versions of those implementations, the instructions to determine whether a corresponding segment of the responsive content matches a corresponding segment of the GM training dataset that was utilized to train the GM may include instructions to: generate, using a hash function, a plurality of corresponding hashes for the responsive content; compare the plurality of corresponding hashes for the responsive content to a plurality of corresponding hashes for the GM training dataset that was utilized to train the GM; and determine, based on a comparison of the plurality of corresponding hashes for the responsive content to the plurality of corresponding hashes for the GM training dataset, whether a corresponding segment of the responsive content matches a corresponding segment of the GM training dataset that was utilized to train the GM.

In some additional or alternative further versions of those implementations, the at least one processor may be further operable to, prior to receiving the user input that is associated with the client device of the user: generate, using the hash function, the plurality of corresponding hashes for the GM training dataset. Each of the plurality of corresponding hashes for the GM training dataset may include a fixed number of alphanumeric characters starting at a corresponding word boundary of a portion of the GM training dataset, and one or more of the plurality of corresponding hashes for the GM training dataset may include overlapping alphanumeric characters.

In some additional or alternative further versions of those implementations, each of the plurality of corresponding hashes for the responsive content may include a fixed number of alphanumeric characters starting at a corresponding word boundary of the responsive content, and one or more of the plurality of corresponding hashes for the responsive content may include overlapping alphanumeric characters.

In some additional or alternative further versions of those implementations, the plurality of corresponding hashes for the responsive content may be generated subsequent to the responsive content that is responsive to the user input being generated.

In some additional or alternative further versions of those implementations, the instructions to determine whether a corresponding segment of the responsive content matches a corresponding segment of one or more of the plurality of search result documents may be executed in response to determining that a corresponding segment of the responsive content matches a corresponding segment of the GM training dataset based on a comparison of the plurality of corresponding hashes for the responsive content to the plurality of corresponding hashes for the GM training dataset.

In some additional or alternative yet further versions of those implementations, the instructions to determine whether to modify the corresponding segment of the responsive content may be executed in response to determining that there is an exact match between a corresponding segment of the responsive content and a corresponding segment of the user provided content.

In some additional or alternative yet further versions of those implementations, the instructions to determine whether to modify the corresponding segment of the responsive content may be executed in response to determining that there is a fuzzy match between a corresponding segment of the responsive content and a corresponding segment of the user provided content.

In some implementations, a system is provided that includes at least one processor; and memory storing instructions that, when executed by the at least one processor, cause the at least one processor to be operable to: receive user input that is associated with a client device of a user; generate, based on processing at least the user input and using a generative model (GM), responsive content that is responsive to the user input; determine whether a corresponding segment of the responsive content matches a corresponding segment of additional data and based on a corresponding edit distance between the corresponding segment of the responsive content and the corresponding segment of the additional data; in response to determining that a corresponding segment of the responsive content matches a corresponding segment of the additional data: determine, based on a type of the additional data associated with the corresponding segment of the additional data, whether to modify the corresponding segment of the responsive content; in response to determining to modify the corresponding segment of the responsive content based on the type of the additional data associated with the corresponding segment of the additional data: modify at least the corresponding segment of the responsive content to generate modified responsive content; and cause the modified responsive content, and in lieu of the responsive content, to be rendered at the client device of the user; and in response to determining not to modify the corresponding segment of the responsive content based on the type of the additional data associated with the corresponding segment of the additional data: refrain from modifying the corresponding segment of the responsive content; and cause the responsive content to be rendered at the client device of the user. By not only considering exact one-to-one matches between a corresponding segment of the responsive content matches a corresponding segment of additional data, but also considering a corresponding edit distance therebetween, techniques described herein can balance usage of computational resources with accuracy and efficiency in generating the responsive content and/or the modified responsive content.

These and other implementations of technology disclosed herein can optionally include one or more of the following features.

In some implementations, the instructions to determine whether a corresponding segment of the responsive content matches a corresponding segment of additional data and based on the corresponding edit distance between the corresponding segment of the responsive content and the corresponding segment of the additional data may include instructions to: normalize, using one or more normalization operations, the additional to generate normalized additional data; segment the normalized additional data into a plurality of normalized additional data segments; normalize, using the one or more normalization operations, the responsive content to generate normalized responsive content; segment the normalized responsive content into a plurality of normalized responsive content segments; and determine, based on a comparison of the plurality of normalized additional data segments and the plurality of normalized responsive content segments, the corresponding edit distance between the corresponding segment of the responsive content and the corresponding segment of the additional data.

In some versions of those implementations, the instructions to determine the corresponding edit distance between the corresponding segment of the responsive content and the corresponding segment of the additional data and based on the comparison of the plurality of normalized additional data segments and the plurality of normalized responsive content segments may include instructions to: determine a corresponding quantity of alphanumeric characters in a normalized instance of the corresponding segment of the responsive content that need to be inserted, deleted, and/or substituted to result in a normalized instance the corresponding segment of the additional data; and determine the corresponding edit distance between the corresponding segment of the responsive content and the corresponding segment of the additional data as a function of (a) the corresponding quantity of alphanumeric characters in the normalized instance of the corresponding segment of the responsive content that need to be inserted, deleted, and/or substituted to result in the normalized instance the corresponding segment of the additional data; and (b) a corresponding total quantity of alphanumeric characters in the normalized instance of the corresponding segment of the additional data.

In some further versions of those implementations, the instructions to determine the corresponding edit distance between the corresponding segment of the responsive content and the corresponding segment of the additional data as the function of (a) and (b) may include instructions to: divide (a) by (b) to determine the corresponding edit distance between the corresponding segment of the responsive content and the corresponding segment of the additional data.

In additional or alternative further versions of those implementations, determining that a corresponding segment of the responsive content matches a corresponding segment of the additional data may be based on the corresponding edit distance between the corresponding segment of the responsive content and the corresponding segment of the additional data satisfying an edit distance threshold.

In additional or alternative further versions of those implementations, determining that a corresponding segment of the responsive content does not match a corresponding segment of the additional data may be based on the corresponding edit distance between the corresponding segment of the responsive content and the corresponding segment of the additional data failing to satisfy an edit distance threshold.

In some implementations, the at least one processor may be further operable to, in response to determining that no corresponding segment of the responsive content matches a corresponding segment of the additional data: refrain from modifying the corresponding segment of the responsive content; and cause the responsive content to be rendered at the client device of the user.

In some implementations, the type of the additional data associated with the corresponding segment of the additional data may be user provided content that is provided by the user along with the user input and that is processed along with the user input to generate the responsive content.

In some versions of those implementations, determining not to modify the corresponding segment of the responsive content may be based on the type of the additional data associated with the corresponding segment of the additional data being the user provided content that is provided by the user along with the user input and that is processed along with the user input to generate the responsive content.

In some further versions of those implementations, the instructions to determine whether a corresponding segment of the responsive content matches a corresponding segment of additional data and based on the corresponding edit distance between the corresponding segment of the responsive content and the corresponding segment of the additional data may include instructions to: normalize, using one or more normalization operations, the user provided content to generate normalized user provided content; segment the normalized user provided content into a plurality of normalized user provided content segments; normalize, using the one or more normalization operations, the responsive content to generate normalized responsive content; segment the normalized responsive content into a plurality of normalized responsive content segments; and determine, based on a comparison of the plurality of normalized user provided content segments and the plurality of normalized responsive content segments, the corresponding edit distance between the corresponding segment of the responsive content and the corresponding segment of the additional data.

In some yet further versions of those implementations, each of the plurality of normalized user provided content segments may include a fixed number of alphanumeric characters starting at a corresponding word boundary of the user provided content, one or more of the plurality of normalized user provided content segments may include overlapping alphanumeric characters, and the user provided content may be normalized and segmented while the responsive content is being generated. By normalizing and segmenting the user provided content while the responsive content is being generated, latency in causing the responsive content to be rendered at the client device of the user via parallelized processing.

In some yet further additional or alternative versions of those implementations, each of the plurality of normalized responsive content segments may include a fixed number of alphanumeric characters starting at a corresponding word boundary of the responsive content, one or more of the plurality of normalized responsive content segments may include overlapping alphanumeric characters, and the plurality of normalized responsive content segments may be generated subsequent to the responsive content being generated.

In some implementations, the type of the additional data associated with the corresponding segment of the additional data may be one or more of a plurality of search result documents that are obtained based on one or more search queries, that are determined based on the user input, being submitted.

In some versions of those implementations, determining to modify the corresponding segment of the responsive content may be based on the type of the additional data associated with the corresponding segment of the additional data being one or more of the plurality of search result documents that are obtained based on the one or more search queries, that are determined based on the user input, being submitted.

In some further versions of those implementations, the instructions to determine whether a corresponding segment of the responsive content matches a corresponding segment of additional data and based on the corresponding edit distance between the corresponding segment of the responsive content and the corresponding segment of the additional data may include instructions to: normalize, using one or more normalization operations, each of the plurality of search result documents to generate a plurality of normalized search result documents; segment the plurality of normalized search result documents into a plurality of normalized search result document segments; normalize, using the one or more normalization operations, the responsive content to generate normalized responsive content; segment the normalized responsive content into a plurality of normalized responsive content segments; and determine, based on a comparison of the plurality of normalized search result document segments and the plurality of normalized responsive content segments, the corresponding edit distance between the corresponding segment of the responsive content and the corresponding segment of the additional data.

In some yet further versions of those implementations, each of the plurality of normalized search result document segments may include a fixed number of alphanumeric characters starting at a corresponding word boundary of a given one of the plurality of search result documents, one or more of the plurality of normalized search result document segments may include overlapping alphanumeric characters, and the plurality of search result documents may be normalized and segmented while the responsive content that is responsive to the user input is being generated. By normalizing and segmenting the search result documents while the responsive content is being generated, latency in causing the responsive content to be rendered at the client device of the user via parallelized processing.

In some yet further additional or alternative versions of those implementations, each of the plurality of normalized responsive content segments may include a fixed number of alphanumeric characters starting at a corresponding word boundary of the responsive content, one or more of the plurality of normalized responsive content segments may include overlapping alphanumeric characters, and the plurality of normalized responsive content segments may be generated subsequent to the responsive content that is responsive to the user input being generated.

In some implementations, the type of the additional data associated with the corresponding segment of the additional data may be a GM training dataset that was utilized to train the GM.

In some versions of those implementations, determining to modify the corresponding segment of the responsive content may be based on the type of the additional data associated with the corresponding segment of the additional data being GM training dataset that was utilized to train the GM.

In some further versions of those implementations, the instructions to determine whether a corresponding segment of the responsive content matches a corresponding segment of additional data and based on the corresponding edit distance between the corresponding segment of the responsive content and the corresponding segment of the additional data may include instructions to: normalize, using one or more normalization operations, the responsive content to generate normalized responsive content; segment the normalized responsive content into a plurality of normalized responsive content segments; and determine, based on a comparison of the plurality of normalized responsive content segments and a plurality of normalized GM training dataset segments for the GM training dataset, the corresponding edit distance between the corresponding segment of the responsive content and the corresponding segment of the additional data.

In some yet further versions of those implementations, each of the plurality of normalized responsive content segments may include a fixed number of alphanumeric characters starting at a corresponding word boundary of the responsive content, one or more of the plurality of normalized responsive content segments may include overlapping alphanumeric characters, and the plurality of normalized responsive content segments may be generated subsequent to the responsive content that is responsive to the natural language prompt being generated.

In some yet further additional or alternative versions of those implementations, the at least one processor may be further operable to, prior to receiving the user input that is associated with the client device of the user: normalize, using the one or more normalization operations, the GM training dataset to generate a normalized GM training dataset; and segment the normalized GM training dataset into the plurality of normalized GM training dataset segments. Each of the plurality of normalized GM training dataset segments for the GM training dataset may include a fixed number of alphanumeric characters starting at a corresponding word boundary of a portion of the GM training dataset, and one or more of the plurality of normalized GM training dataset segments may include overlapping alphanumeric characters.

In some implementations, modifying at least the corresponding segment of the responsive content to generate the modified responsive content may be based on a type of one or more of the sources associated with the corresponding segment of the additional data that matches the corresponding segment of the responsive content.

In some implementations, the instructions to cause the modified responsive content to be rendered at the client device of the user may include instructions to: transmit data indicative of the modified responsive content to the client device. Transmitting the data indicative of the modified responsive content to the client device may cause the client device to visually render the modified responsive content via a display of the client device and/or audibly render the modified responsive content via one or more speakers of the client device.

In some implementations, the instructions to cause the modified responsive content to be rendered at the client device of the user may include instructions to: cause the modified responsive content to be visually rendered via a display of the client device and/or audibly rendered via one or more speakers of the client device.

In some implementations, the instructions to cause the responsive content to be rendered at the client device of the user may include instructions to: transmit data indicative of the responsive content to the client device. Transmitting the data indicative of the responsive content to the client device may cause the client device to visually render the responsive content via a display of the client device and/or audibly render the responsive content via one or more speakers of the client device.

In some implementations, the instructions to cause the responsive content to be rendered at the client device of the user may include instructions to: cause the responsive content to be visually rendered via a display of the client device and/or audibly rendered via one or more speakers of the client device.

In some implementations, the at least one processor may be further operable to: determine whether a corresponding segment of the responsive content is an exact match to a corresponding segment of additional data. The instructions to determine whether a corresponding segment of the responsive content matches a corresponding segment of additional data and based on the corresponding edit distance between the corresponding segment of the responsive content and the corresponding segment of the additional data may be executed in response to determining that a corresponding segment of the responsive content is not an exact match to a corresponding segment of additional data.

In some versions of those implementations, the instructions to determine whether a corresponding segment of the responsive content is an exact match to a corresponding segment of additional data may include instructions to: generate, using the hash function, a plurality of corresponding hashes for the responsive content; compare a plurality of corresponding hashes for additional to the plurality of corresponding hashes for the responsive content; and determine, based on a comparison of the plurality of corresponding hashes for the one or more of the plurality of search result documents to the plurality of corresponding hashes for the responsive content, whether a corresponding segment of the responsive content is an exact match to a corresponding segment of additional data.

In some implementations, determining whether a corresponding segment of the responsive content matches the corresponding segment of the additional data can be further based on comparing a corresponding representation of the corresponding segment of the responsive content to a corresponding representation of the corresponding segment of the additional data.

In some versions of those implementations, the additional data can be user provided content that is received along with the user input, the corresponding representation of the corresponding segment of the additional data can be generated in response to receiving the user provided content, and the corresponding representation of the corresponding segment of the responsive content can be generated in response to generating the responsive content.

In some further versions of those implementations, the corresponding representation of the corresponding segment of the additional data can be generated prior to the user submitting the user input but after the user has provided the user provided content.

In additional or alternative versions of those implementations, the additional data can be a portion of one or more of a plurality of search result documents obtained based on processing the user input, the corresponding representation of the corresponding segment of the additional data can be generated in response to obtaining the plurality of search result documents, and the corresponding representation of the corresponding segment of the responsive content can be generated in response to generating the responsive content.

In additional or alternative versions of those implementations, the additional data can be a GM training dataset that was utilized to train or fine-tune the GM, the corresponding representation of the corresponding segment of the additional data can be generated prior to receiving the user input, and the corresponding representation of the corresponding segment of the responsive content can be generated in response to generating the responsive content.

In additional or alternative versions of those implementations, the corresponding representation of the corresponding segment of the responsive content can be one of a corresponding vector or embedding representation of the corresponding segment of the responsive content, or a corresponding bag-of-words representation of the corresponding segment of the responsive content, and the corresponding representation of the corresponding segment of the additional data can also be one of a corresponding vector or embedding representation of the corresponding segment of the additional data, or a corresponding bag-of-words representation of the corresponding segment of the additional data.

In additional or alternative versions of those implementations, comparing the corresponding representation of the corresponding segment of the responsive content to the corresponding representation of the corresponding segment of the additional data can be in response to determining that the corresponding edit distance between the corresponding segment of the responsive content and the corresponding segment of the additional data fails to satisfy an edit distance threshold.

In some further versions of those implementations, comparing the corresponding representation of the corresponding segment of the responsive content to the corresponding representation of the corresponding segment of the additional data can be further in response to determining that the corresponding edit distance between the corresponding segment of the responsive content and the corresponding segment of the additional data is within a threshold range of the edit distance threshold.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the steps of the aforementioned systems. Some implementations also include a method implemented by one or more processors to perform any of the steps of the aforementioned systems.

What is claimed is:

1. A system comprising:
at least one processor; and
memory storing instructions that, when executed by the at least one processor, cause the at least one processor to be operable to:
receive user input that is associated with a client device of a user;
generate, based on processing at least the user input and using a generative model (GM), responsive content that is responsive to the user input;
determine whether a corresponding segment of the responsive content matches a corresponding segment of additional data and based on a corresponding edit distance between the corresponding segment of the responsive content and the corresponding segment of the additional data;
in response to determining that a corresponding segment of the responsive content matches a corresponding segment of the additional data:
determine, based on a type of the additional data associated with the corresponding segment of the additional data, whether to modify the corresponding segment of the responsive content;
in response to determining to modify the corresponding segment of the responsive content based on the type of the additional data associated with the corresponding segment of the additional data:
modify at least the corresponding segment of the responsive content to generate modified responsive content; and
cause the modified responsive content, and in lieu of the responsive content, to be rendered at the client device of the user; and
in response to determining not to modify the corresponding segment of the responsive content based on the type of the additional data associated with the corresponding segment of the additional data:
refrain from modifying the corresponding segment of the responsive content; and
cause the responsive content to be rendered at the client device of the user.

2. The system of claim 1, wherein the instructions to determine whether a corresponding segment of the responsive content matches a corresponding segment of additional data and based on the corresponding edit distance between the corresponding segment of the responsive content and the corresponding segment of the additional data comprise instructions to:
normalize, using one or more normalization operations, the additional to generate normalized additional data;
segment the normalized additional data into a plurality of normalized additional data segments;
normalize, using the one or more normalization operations, the responsive content to generate normalized responsive content;
segment the normalized responsive content into a plurality of normalized responsive content segments; and
determine, based on a comparison of the plurality of normalized additional data segments and the plurality of normalized responsive content segments, the corresponding edit distance between the corresponding segment of the responsive content and the corresponding segment of the additional data.

3. The system of claim 2, wherein the instructions to determine the corresponding edit distance between the corresponding segment of the responsive content and the corresponding segment of the additional data and based on the comparison of the plurality of normalized additional data segments and the plurality of normalized responsive content segments comprise instructions to:
determine a corresponding quantity of alphanumeric characters in a normalized instance of the corresponding segment of the responsive content that need to be inserted, deleted, and/or substituted to result in a normalized instance the corresponding segment of the additional data; and
determine the corresponding edit distance between the corresponding segment of the responsive content and the corresponding segment of the additional data as a function of (a) the corresponding quantity of alphanumeric characters in the normalized instance of the corresponding segment of the responsive content that need to be inserted, deleted, and/or substituted to result in the normalized instance the corresponding segment of the additional data; and (b) a corresponding total quantity of alphanumeric characters in the normalized instance of the corresponding segment of the additional data.

4. The system of claim 3, wherein the instructions to determine the corresponding edit distance between the corresponding segment of the responsive content and the corresponding segment of the additional data as the function of (a) and (b) comprise instructions to:
divide (a) by (b) to determine the corresponding edit distance between the corresponding segment of the responsive content and the corresponding segment of the additional data.

5. The system of claim 3, wherein determining that a corresponding segment of the responsive content matches a corresponding segment of the additional data is based on the corresponding edit distance between the corresponding segment of the responsive content and the corresponding segment of the additional data satisfying an edit distance threshold.

6. The system of claim 3, wherein determining that a corresponding segment of the responsive content does not match a corresponding segment of the additional data is based on the corresponding edit distance between the corresponding segment of the responsive content and the corresponding segment of the additional data failing to satisfy an edit distance threshold.

7. The system of claim 1, wherein the at least one processor is further operable to:
in response to determining that no corresponding segment of the responsive content matches a corresponding segment of the additional data:
refrain from modifying the corresponding segment of the responsive content; and
cause the responsive content to be rendered at the client device of the user.

8. The system of claim 1, wherein the type of the additional data associated with the corresponding segment of the additional data is user provided content that is provided by the user along with the user input and that is processed along with the user input to generate the responsive content.

9. The system of claim 8, wherein determining not to modify the corresponding segment of the responsive content is based on the type of the additional data associated with the corresponding segment of the additional data being the user provided content that is provided by the user along with the user input and that is processed along with the user input to generate the responsive content.

10. The system of claim 9, wherein the instructions to determine whether a corresponding segment of the responsive content matches a corresponding segment of additional data and based on the corresponding edit distance between the corresponding segment of the responsive content and the corresponding segment of the additional data comprise instructions to:
normalize, using one or more normalization operations, the user provided content to generate normalized user provided content;
segment the normalized user provided content into a plurality of normalized user provided content segments;
normalize, using the one or more normalization operations, the responsive content to generate normalized responsive content;
segment the normalized responsive content into a plurality of normalized responsive content segments; and
determine, based on a comparison of the plurality of normalized user provided content segments and the plurality of normalized responsive content segments, the corresponding edit distance between the corresponding segment of the responsive content and the corresponding segment of the additional data.

11. The system of claim 10, wherein each of the plurality of normalized user provided content segments include a fixed number of alphanumeric characters starting at a corresponding word boundary of the user provided content, wherein one or more of the plurality of normalized user provided content segments include overlapping alphanumeric characters, and wherein the user provided content is normalized and segmented while the responsive content is being generated.

12. The system of claim 10, wherein each of the plurality of normalized responsive content segments include a fixed number of alphanumeric characters starting at a corresponding word boundary of the responsive content, wherein one or more of the plurality of normalized responsive content segments include overlapping alphanumeric characters, and wherein the plurality of normalized responsive content segments are generated subsequent to the responsive content being generated.

13. The system of claim 1, wherein the type of the additional data associated with the corresponding segment of the additional data is one or more of a plurality of search result documents that are obtained based on one or more search queries, that are determined based on the user input, being submitted.

14. The system of claim 13, wherein determining to modify the corresponding segment of the responsive content is based on the type of the additional data associated with the corresponding segment of the additional data being one or more of the plurality of search result documents that are obtained based on the one or more search queries, that are determined based on the user input, being submitted.

15. The system of claim 14, wherein the instructions to determine whether a corresponding segment of the responsive content matches a corresponding segment of additional data and based on the corresponding edit distance between the corresponding segment of the responsive content and the corresponding segment of the additional data comprise instructions to:
normalize, using one or more normalization operations, each of the plurality of search result documents to generate a plurality of normalized search result documents;
segment the plurality of normalized search result documents into a plurality of normalized search result document segments;
normalize, using the one or more normalization operations, the responsive content to generate normalized responsive content;
segment the normalized responsive content into a plurality of normalized responsive content segments; and
determine, based on a comparison of the plurality of normalized search result document segments and the plurality of normalized responsive content segments, the corresponding edit distance between the corresponding segment of the responsive content and the corresponding segment of the additional data.

16. The system of claim 15, wherein each of the plurality of normalized search result document segments include a fixed number of alphanumeric characters starting at a corresponding word boundary of a given one of the plurality of search result documents, wherein one or more of the plurality of normalized search result document segments include overlapping alphanumeric characters, and wherein the plurality of search result documents are normalized and segmented while the responsive content that is responsive to the user input is being generated.

17. The system of claim 15, wherein each of the plurality of normalized responsive content segments include a fixed number of alphanumeric characters starting at a corresponding word boundary of the responsive content, wherein one or more of the plurality of normalized responsive content segments include overlapping alphanumeric characters, and wherein the plurality of normalized responsive content segments are generated subsequent to the responsive content that is responsive to the user input being generated.

18. The system of claim 1, wherein the type of the additional data associated with the corresponding segment of the additional data is a GM training dataset that was utilized to train the GM, and wherein determining to modify the corresponding segment of the responsive content is based on the type of the additional data associated with the corresponding segment of the additional data being GM training dataset that was utilized to train the GM.

19. A method implemented by one or more processors, the method comprising:
receiving user input that is associated with a client device of a user;
generating, based on processing at least the user input and using a generative model (GM), responsive content that is responsive to the user input;
determining whether a corresponding segment of the responsive content matches a corresponding segment of additional data and based on a corresponding edit distance between the corresponding segment of the responsive content and the corresponding segment of the additional data;
in response to determining that a corresponding segment of the responsive content matches a corresponding segment of the additional data:
determining, based on a type of the additional data associated with the corresponding segment of the additional data, whether to modify the corresponding segment of the responsive content;
in response to determining to modify the corresponding segment of the responsive content based on the type of the additional data associated with the corresponding segment of the additional data:
modifying at least the corresponding segment of the responsive content to generate modified responsive content; and
causing the modified responsive content, and in lieu of the responsive content, to be rendered at the client device of the user; and
in response to determining not to modify the corresponding segment of the responsive content based on the type of the additional data associated with the corresponding segment of the additional data:
refraining from modifying the corresponding segment of the responsive content; and
causing the responsive content to be rendered at the client device of the user.

20. A non-transitory computer-readable storage medium storing computer-readable instructions that, when executed by at least one processor, cause the at least one processor to:
receive user input that is associated with a client device of a user;
generate, based on processing at least the user input and using a generative model (GM), responsive content that is responsive to the user input;
determine whether a corresponding segment of the responsive content matches a corresponding segment of additional data and based on a corresponding edit distance between the corresponding segment of the responsive content and the corresponding segment of the additional data;
in response to determining that a corresponding segment of the responsive content matches a corresponding segment of the additional data:
determine, based on a type of the additional data associated with the corresponding segment of the additional data, whether to modify the corresponding segment of the responsive content;
in response to determining to modify the corresponding segment of the responsive content based on the type of the additional data associated with the corresponding segment of the additional data:
modify at least the corresponding segment of the responsive content to generate modified responsive content; and
cause the modified responsive content, and in lieu of the responsive content, to be rendered at the client device of the user; and
in response to determining not to modify the corresponding segment of the responsive content based on the type of the additional data associated with the corresponding segment of the additional data:
refrain from modifying the corresponding segment of the responsive content; and
cause the responsive content to be rendered at the client device of the user.
